(19) United States
(12) Patent Application Publication
(10) Pub. No.: US 2026/0212413 A1
(43) Pub. Date: Jul. 23, 2026

(54) TRANSACTION FLOW WITH MASTER ACCOUNT LEDGER AND ESCROW LEDGER INTERACTION

(71) Applicant: TRETE Inc., Prosper, TX (US)

(72) Inventors: Damien Patton, Plano, TX (US); Christian Gratton, Eaton Rapids, MI (US); Rish Mehta, Castro Valley, CA (US)

(21) Appl. No.: 19/340,743

(22) Filed: Sep. 25, 2025

Related U.S. Application Data
(63) Continuation-in-part of application No. 19/301,891, filed on Aug. 15, 2025.
Application No. 19/301,891 is a continuation-in-part of application No. 19/180,793, filed on Apr. 16, 2025.
Application No. 19/180,793 is a continuation of application No. 18/959,306, filed on Nov. 25, 2024, now Pat. No. 12,288,259.
Application No. 18/959,306 is a continuation of application No. 18/616,180, filed on Mar. 26, 2024, now Pat. No. 12,182,866.
(60) Provisional application No. 63/454,622, filed on Mar. 24, 2023.
(60) Provisional application No. 63/509,266, filed on Jun. 20, 2023.
(60) Provisional application No. 63/509,264, filed on Jun. 20, 2023.
(60) Provisional application No. 63/509,261, filed on Jun. 20, 2023.
(60) Provisional application No. 63/509,257, filed on Jun. 20, 2023.
(60) Provisional application No. 63/515,337, filed on Jul. 24, 2023.
(60) Provisional application No. 63/596,471, filed on Nov. 6, 2023.
(60) Provisional application No. 63/600,381, filed on Nov. 17, 2023.
(60) Provisional application No. 63/615,145, filed on Dec. 27, 2023.
(60) Provisional application No. 63/615,136, filed on Dec. 27, 2023.
(60) Provisional application No. 63/615,128, filed on Dec. 27, 2023.
(60) Provisional application No. 63/615,108, filed on Dec. 27, 2023.

(51) Int. Cl. G06Q 40/04; G06F 16/215; G06F 16/23; G06F 16/27; G06Q 20/36; G06Q 20/38; G06Q 20/40; G06Q 20/42; G06Q 30/0601; G06Q 40/06; H04L 9/00; H04L 67/1097

(52) U.S. Cl. CPC G06Q 40/04; G06F 16/215; G06F 16/2358; G06F 16/2379; G06F 16/275; G06Q 20/363; G06Q 20/3674; G06Q 20/3829; G06Q 20/389; G06Q 20/401; G06Q 20/42; G06Q 30/0613; G06Q 40/06; H04L 9/50; H04L 67/1097; G06F 16/2365; G06F 16/27; G06Q 2220/00

(57) ABSTRACT

A system and method for completing a sale of digital shares representing an interest in an asset in an exchange, wherein the exchange comprising a transfer agent, includes registering, by the transfer agent, a user on an exchange; presenting to the user, by the transfer agent an interface allowing the user to select an interest in an asset to sell; communicating, by the transfer agent, with a broker dealer to transmit a sell contract to the user; pairing, by the transfer agent, a buyer with the user to sell the interest in the asset to the buyer; and executing, by the transfer agent, a sale of digital shares representing the interest in the asset.

### CROSS REFERENCE TO RELATED APPLICATIONS

The present application is continuation in part of U.S. patent application Ser. No. 19/301,891, entitled “Transaction Flow With Master Account Ledger And Escrow Ledger”, filed Aug. 15, 2025, which is incorporated herein in its entirety.

U.S. patent application Ser. No. 19/301,891 is a continuation in part of U.S. patent application Ser. No. 19/180,793, entitled “Transaction Flow With Master Account Ledger And Escrow Ledger”, filed Apr. 16, 2025, which is incorporated herein in its entirety.

U.S. patent application Ser. No. 19/180,793 is a continuation of U.S. patent application Ser. No. 18/959,306, now U.S. Pat. No. 12,288,259, entitled, “Transaction Flow With Master Account Ledger And Escrow Ledger”, filed Nov. 25, 2024, which is incorporated herein in its entirety.

U.S. patent application Ser. No. 18/959,306 is a continuation of U.S. patent application Ser. No. 18/616,180, now U.S. Pat. No. 12,182,866, entitled “Transaction Flow With Master Account Ledger And Escrow Ledger”, filed Mar. 26, 2024, which is incorporated herein in its entirety.

U.S. patent application Ser. No. 18/616,180 claims the benefit of priority under 35 U.S.C. § 119 from U.S. Provisional Patent Application Ser. No. 63/454,622, entitled “Transaction Platform With Synchronized Semi-Redundant Ledgers,” filed on Mar. 24, 2023, all of which is incorporated herein by reference in its entirety for all purposes. U.S. patent application Ser. No. 18/616,180 claims the benefit of priority under 35 U.S.C. § 119 from U.S. Provisional Patent Application Ser. No. 63/509,257, entitled “Data Retrieval and Validation for Asset Onboarding,” filed on Jun. 20, 2023, all of which is incorporated herein by reference in its entirety for all purposes. U.S. patent application Ser. No. 18/616,180 claims the benefit of priority under 35 U.S.C. § 119 from U.S. Provisional Patent Application Ser. No. 63/509,261, entitled “Data Validation and Assessment Valuation,” filed on Jun. 20, 2023, all of which is incorporated herein by reference in its entirety for all purposes. U.S. patent application Ser. No. 18/616,180 claims the benefit of priority under 35 U.S.C. § 119 from U.S. Provisional Patent Application Ser. No. 63/509,264, entitled “Secure Identifier Integration,” filed on Jun. 20, 2023, all of which is incorporated herein by reference in its entirety for all purposes. U.S. patent application Ser. No. 18/616,180 claims the benefit of priority under 35 U.S.C. § 119 from U.S. Provisional Patent Application Ser. No. 63/509,266, entitled “Dual Ledger Syncing,” filed on Jun. 20, 2023, all of which is incorporated herein by reference in its entirety for all purposes. U.S. patent application Ser. No. 18/616,180 claims the benefit of priority under 35 U.S.C. § 119 from U.S. Provisional Patent Application Ser. No. 63/515,337, entitled “Metadata Process, with Static and Evolving Attributes, Introduced into Tokenization Standards,” filed on Jul. 24, 2023, all of which is incorporated herein by reference in its entirety for all purposes. U.S. patent application Ser. No. 18/616,180 claims the benefit of priority under 35 U.S.C. § 119 from U.S. Provisional Patent Application Ser. No. 63/596,471, entitled “Real Asset Fractionalization Algorithm,” filed on Nov. 6, 2023, all of which is incorporated herein by reference in its entirety for all purposes. U.S. patent application Ser. No. 18/616,180 claims the benefit of priority under 35 U.S.C. § 119 from U.S. Provisional Patent Application Ser. No. 63/600,381, entitled “Settlement and Approval Service,” filed on Nov. 17, 2023, all of which is incorporated herein by reference in its entirety for all purposes. U.S. patent application Ser. No. 18/616,180 claims the benefit of priority under 35 U.S.C. § 119 from U.S. Provisional Patent Application Ser. No. 63/615,108, entitled “Live Syncing Capitalization Table System,” filed on Dec. 27, 2023, all of which is incorporated herein by reference in its entirety for all purposes. U.S. patent application Ser. No. 18/616,180 claims the benefit of priority under 35 U.S.C. § 119 from U.S. Provisional Patent Application Ser. No. 63/615,128, entitled “Transaction Flow with Master Account Ledger and Escrow Ledger Interaction,” filed on Dec. 27, 2023, all of which is incorporated herein by reference in its entirety for all purposes. U.S. patent application Ser. No. 18/616,180 claims the benefit of priority under 35 U.S.C. § 119 from U.S. Provisional Patent Application Ser. No. 63/615,136, entitled “Regenerative Model-Continuous Evolution System (“RM-CES”),” filed on Dec. 27, 2023, all of which is incorporated herein by reference in its entirety for all purposes. U.S. patent application Ser. No. 18/616,180 claims the benefit of priority under 35 U.S.C. § 119 from U.S. Provisional Patent Application Ser. No. 63/615,145, entitled “Transaction & Settlement Validation Service (“TSVS”),” filed on Dec. 27, 2023, all of which is incorporated herein by reference in its entirety for all purposes.

### TECHNICAL FIELD

The present disclosure generally relates to blockchain technology, e.g., cryptographically encoded ledgers distributed across a computing network, and more specifically relates to transaction platforms with semi-redundant ledgers.

### BACKGROUND

There is a need for a technology platform that can create digital securities out of what are known as “real assets” and can function as a market platform or Financial Exchange for these types of assets as well as for other types of assets such as, but not limited to, investments in franchises, investments in business that generate dividends or returns based on performance of the business or underlying asset, investments in ventures that capture or mine natural resource such as, but not limited to uranium, timber, and other commodities, private credit, private debt, intangible assets, tradeable assets, and any other types of appropriate assets. Examples of real assets include office buildings, multi-family apartment buildings, car washes, private planes or yachts, antique cars, art, jewelry, insurance policies, and even structured products that are based on the performance of an underlying asset (e.g. a racehorse). It should be understood that the disclosed technology is not limited to creating digital securities.

Real estate, for example, has long been a preferred investment, offering competitive risk-adjusted returns and a hedge against inflation. Direct investments in industries, such as real estate, e.g., purchasing real estate directly, involves deploying and risking large initial and ongoing financial sums. In contrast, indirect investments, e.g., Real Estate Investment Trusts (REITs) and other deal structures and/or securities that pool sums of money from multiple investors together to purchase investments, facilitate individual investors deploying and risking smaller initial and ongoing financial sums. Such indirect investments also involve other costs and require compliance with relevant securities statutes and regulations.

The description provided in the background section should not be assumed to be prior art merely because it is mentioned in or associated with the background section. The background section may include information that describes one or more aspects of the subject technology.

### SUMMARY

An exemplary aspect relates to an electronic and computer technology platform for facilitating a “closed” electronic market exchange for tokens (e.g., cryptographic tokens that represent shares or other interests in real estate and/or other assets) which are created by and may be traded by participants registered and validated by a computer system integrated within the technology platform (as opposed to third party token marketplaces). The technology platform includes a novel specialized computer architecture and customized computer code adapted and programmed to implement novel functions that are not currently and have not previously been performed with prior asset exchange platforms. Novel aspects include semi-redundant ledgers that are automatically synchronized by the computer system and which overcome other technical limitations of prior transaction management systems.

An exemplary aspect relates to a pair of synchronized semi-redundant ledgers that maintain a public record of each transaction executed on the platform (for example, recorded on a blockchain), in which personally identifiable information (PII) of parties to the transaction are not disclosed and therefore not publicly accessible via the semi-redundant ledgers. In other aspects, the pair of synchronized semi-redundant ledgers maintain, instead, a private record of each transaction. An example can be a regular ledger of any type that is backed up and synchronized with a blockchain (public or private ledger). This automated auditing mechanism facilitates fraud, theft, and loss (if used for inventory instead of real assets). For example, a Consumer Packaged Goods (“CPG”) company could keep their entire inventory system on the blockchain to audit stores to control shrinkage, loss, and/or theft.

An exemplary aspect of the disclosed technology includes a computer system specially configured and programmed to perform functions of a transaction platform that includes a network-accessible computer server system with semi-redundant ledgers which are automatically synchronized by the computer system. The semi-redundant ledgers include a first ledger type that may include a database (e.g., centrally controlled by an operator of the computer system); a tokenization module configured to create and/or manage tokens as described herein and configured to interact with a second ledger (e.g., a blockchain); a digital wallet management module configured to receive, store, and transmit digital tokens; and a role-based access module configured to validate participants and their authorized roles as well as authorize and/or limit the participants'functional interactions with the computer system based on their approved roles. The transaction platform with semi-redundant ledgers may provide mechanisms by which investors may trade and/or exchange (e.g., acquire and/or transfer) tokenized portions of real estate/real properties while remaining anonymous (as described herein). The tokenized portions of real estate/real properties may be referred to herein as “asset tokens.” The mechanisms by which the investors may trade and/or exchange tokenized portions of real estate/real properties may include tokenization and a dual ledger system. The transaction platform may facilitate a property owner to tokenize the property by generating multiple tokens collectively representing the value of the property. The transaction platform may facilitate investors to browse listed properties and tokens representing fractional shares of the value of one or more properties. The transaction platform may facilitate investors to acquire and transfer the tokens.

An exemplary aspect of the disclosed technology may include the transaction platform being specially configured and programmed to record token transactions in two semi-redundant ledgers on a computing network. One ledger, referred to herein as the “primary ledger,” is configured to maintain data stored therein as confidential. The primary ledger may be internal to the transaction platform. In the primary ledger, asset token transactions may be recorded in association with personally identifiable information (PII) of the buyer and seller of the token. The transactions are also recorded in a public or private ledger, referred to herein as the “secondary ledger.” The secondary ledger may be implemented as a blockchain. In certain aspects, the secondary ledger is configured to support immutable features. The secondary ledger may be configured to not store personally identifiable information (PII) of the buyer(s) or seller(s).

While exemplary aspects of the transaction platform are described herein with reference to an underlying real estate or real property asset, it should be understood that the technology disclosed herein may be applied to any type of underlying asset.

An exemplary method of exchanging digital assets representing fractional interests in an asset includes receiving information regarding characteristics of an asset and generating a plurality of digital assets representing fractional interests in the asset. The method also includes establishing a smart contract for exchanging at least one of the plurality of digital assets held by a first entity for trade proceeds from a second entity. The method additionally includes performing a transaction according to the smart contract, and updating a capitalization table based on the performed transaction. The method further includes recording data pertaining to the performed transaction on a blockchain.

Others may be notified of the information regarding characteristics of an asset. Others may be invited to propose an exchange for at least one of the plurality of digital assets representing fractional interests in the asset. A proposal of an exchange for at least one of the plurality of digital assets may be received. Establishing the smart contract for the exchange for at least one of the plurality of digital assets may be responsive to receiving the proposal of the exchange.

The method may further include waiting a predefined period of time after a current owner's acquisition of the asset prior to inviting others to propose an exchange for at least one of the plurality of digital assets representing fractional interests in the asset. Transaction fees may be collected from at least one of the first entity and the second entity, the transaction fees set according to the smart contract governing the performed transaction. At least some of the collected transaction fees may be distributed as license fees to a third entity. Settlement statements pertaining to the performed transaction may be distributed to at least one of the first entity and the second entity. The method may additionally include recording transaction data pertaining to the performed transaction, including personally identifiable information of at least one of the first entity or the second entity, in a primary ledger configured to maintain the transaction data as confidential, and recording transaction data pertaining to the performed transaction, absent personally identifiable information of the first entity and the second entity, in a secondary ledger configured to make the transaction data publicly or privately available on a blockchain. The asset may include real estate, for example, and the digital assets representing fractional interests in the asset may include nonfungible tokens (NFTs), and/or, but is not limited to, fungible tokens, hybrid tokens, cryptocurrencies, crypto tokens, crypto coins, security token, and asset tokens, having metadata including identification information of the buyer of the NFTs. The smart contract may be established by a broker/dealer with at least one of the first entity or the second entity.

An exemplary non-transitory computer readable medium stores computer-readable instructions executable by a hardware computing processor to perform operations of a method for recording transactions with semi-redundant ledgers as described herein.

An exemplary system for recording transactions with semi-redundant ledgers includes at least one device including a hardware computing processor, the system being configured to perform operations of a method for recording transactions with semi-redundant ledgers as described herein. The system may include a non-transitory memory having stored thereon computing instructions, executable by the hardware computing processor, to perform operations of a method for recording transactions with semi-redundant ledgers as described herein.

An exemplary system for recording transactions with semi-redundant ledgers includes at least one device including a hardware circuit operable to perform a function, the system being configured to perform operations of a method for recording transactions with semi-redundant ledgers as described herein.

According to certain aspects of the present disclosure, a computer-implemented method is provided. The method includes registering, by the transfer agent a user on an exchange. The method includes presenting to the user, by the transfer agent, an interface allowing the user to select an interest in an asset to sell. The method includes communicating, by the transfer agent, with a broker dealer to transmit a sell contract to the user. The method includes pairing, by the transfer agent, a buyer with the user to sell the interest in the asset to the buyer. The method includes executing, by the transfer agent, a sale of digital assets representing the interest in the asset.

According to certain aspects of the present disclosure, a system is provided. The system includes one or more memories comprising instructions and one or more processors configured to execute the instructions which, when executed, cause the one or more processors to register, by the transfer agent, a user on an exchange. The one or more processors is configured to execute the instructions which, when executed, cause the one or more processors to present to the user, by the transfer agent, an interface allowing the user to select an interest in an asset to sell. The one or more processors is configured to execute the instructions which, when executed, cause the one or more processors to communicate, by the transfer agent, with a broker dealer to transmit a sell contract to the user. The one or more processors is configured to execute the instructions which, when executed, cause the one or more processors to pair, by the transfer agent, a buyer with the user to sell the interest in the asset to the buyer. The one or more processors is configured to execute the instructions which, when executed, cause the one or more processors to execute, by the transfer agent, a sale of digital shares representing the interest in the asset.

According to other aspects of the present disclosure, a non-transitory machine-readable storage medium comprising machine-readable instructions for causing a processor to execute a method is provided. The method includes registering, by the transfer agent, a user on an exchange. The method includes presenting to the user, by the transfer agent, an interface allowing the user to select an interest in an asset to sell. The method includes communicating, by the transfer agent, with a broker dealer to transmit a sell contract to the user. The method includes pairing, by the transfer agent, a buyer with the user to sell the interest in the asset to the buyer. The method includes executing, by the transfer agent, a sale of digital assets representing the interest in the asset.

### BRIEF DESCRIPTION OF DRAWINGS

The disclosure is better understood with reference to the following drawings and description. The elements in the figures are not necessarily to scale, emphasis instead being placed upon illustrating the principles of the disclosure. Moreover, in the figures, like-referenced numerals may designate to corresponding parts throughout the different views.

FIG. 1 is a block diagram illustrating an exemplary technological system including a transaction platform having semi-redundant ledgers.

FIG. 2 illustrates an exemplary process for tokenization of an asset, according to some embodiments of the disclosed technology.

FIG. 3 illustrates an exemplary process for user onboarding and account creation, according to some embodiments of the disclosed technology.

FIG. 4 illustrates an exemplary process for acquiring and transferring asset tokens on the transaction platform of FIG. 1, according to some embodiments of the disclosed technology.

FIG. 5 illustrates an exemplary seller login and transaction flow using the exemplary transaction platform of the system of FIG. 1.

FIG. 6 illustrates an exemplary buyer login and transaction flow 600 using the exemplary transaction platform of the system of FIG. 1.

FIG. 7 illustrates an exemplary fee flow using the exemplary transaction platform of the system of FIG. 1.

FIG. 8 depicts a block diagram of an example computer system in which embodiments described herein may be implemented.

FIG. 9 illustrates an exemplary sign up and claim flow using the exemplary transaction platform of the system of FIG. 1.

FIGS. 10A, 10B, and 10C collectively illustrate an exemplary sell flow using the exemplary transaction platform of the system of FIG. 1.

FIGS. 11A, 11B, and 11C collectively illustrate an exemplary buy flow using the exemplary transaction platform of the system of FIG. 1.

FIG. 12 illustrates an example computer architecture that facilitates determining stablecoin stability.

FIG. 13 illustrates a flow chart of an example method for determining stablecoin stability.

FIG. 14 illustrates an example computer architecture that facilitates handling currency conversions associated with digital asset transactions.

FIG. 15 illustrates a flow chart of an example method for handling currency conversions associated with digital asset transactions.

FIG. 16 illustrates an example computer architecture that facilitates settling a transaction including currency conversions.

FIG. 17 illustrates a flow chart of an example method for settling a transaction including currency conversions.

FIG. 18 illustrates a flow chart of an example method for settling a crypto currency transaction

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

In general, aspects of the invention manage conversions between crypto, stablecoin, and fiat (with possible reference to currency pairs) at digital platforms functioning as intermediaries between different parties to a transaction, such as, for example, a transaction transferring ownership of a digital asset in exchange for currency. It may be that parties want to transact in different currency types. For example, one party to a transaction (e.g., a buyer or seller) may want to transact in crypto and a counter party to the transaction (e.g., the other of the buyer or seller) may want to transact in fiat. Further, one party may not even be interested in transacting with others that utilize a particular type of currency. For example, a seller transacting in fiat may not want to transact with a buyer transacting in crypto (e.g. due to the hassle of converting crypto to fiat, crypto volatility, etc.). Likewise, a seller transacting in crypto may not want to transact with a buyer transacting in fiat (e.g., due to centralized management of fiat, etc.).

Some parties may be ok transacting with others when permitted to interact with a digital platform (e.g., an Alternative Trading System (ATS), such as, ATS 100) in a preferred currency type and remaining blind to a currency type of counter parties. In these aspects, the digital platform (e.g., the ATS) can handle conversions (e.g., by referring to currency pairs), mitigate risks of the transacting parties, etc. increasing comfort of parties using the digital platform.

In one aspect, a digital platform, such as, an Alternative Trading System (ATS), electronically receives an exchange proposal proposing a second entity purchase an interest in an asset from a first entity utilizing a first currency type (e.g., crypto) as payment. Responsive to receiving the exchange proposal, the digital platform formulates a smart contract defining transferring a token, representing the interest in the asset, from the first entity to the second entity in exchange for trade proceeds in a second currency type (e.g., fiat) transferred from the second entity to the first entity.

The digital platform settles the transaction according to the smart contract capturing transaction data documenting the transaction. Transaction settlement includes transferring the token from a digital wallet of the first entity to a digital wallet of the seconding entity. Transaction settlement also includes transferring the trade proceeds from the second entity to the first entity.

Transferring trade proceeds includes accessing an amount of currency in the first currency type from the currency wallet of the second entity. Transferring trade proceeds includes converting the first currency type to an equal valued amount of stablecoin. Transferring trade proceeds includes, subsequent to converting the first currency type to an equal valued amount of stablecoin, converting the amount of stablecoin to an equal valued amount of currency in the second currency type. Transferring trade proceeds includes transferring the amount of currency in the second currency type to a currency wallet of the first entity.

Subsequent and in response to settling the transaction, the digital platform electronically and automatically updates ownership interests in the asset within an electronic capitalization table, including defining the interest in the asset is owned by the second entity and digitally preserves evidence of the transaction settlement in a private mutable ledger and a public immutable ledger. Digitally preserving evidence of the transaction includes recording the transaction data in the private mutable ledger. Digitally preserving evidence of the transaction also includes semi-redundantly synchronizing the public immutable ledger with the private mutable ledger including recording at least a subset of the transaction data in the public immutable ledger.

In this description and the following claims, “fiat currency” is defined as a type of government issued currency backed by the issuing government. The value of fiat currency is based on the public's trust in the issuing government and can vary based on supply and demand. Fiat currency is legal tender. That is, fiat currency is authorized by an issuing government to be used as a medium of exchange. Governments can increase the amount of fiat currency in circulation by issuing more units. Central banks can regulate the supply of money through open market operations, interest rates, and reserve requirements. Examples of fiat currency include: the U.S. dollar, the British pound, the Indian Rupee, and the euro. Hereinafter, fiat currency may be referred to simply as “fiat”.

In this description and the following claims, “crypto currency” is defined as a digital currency designed to work through a computer network and is not reliant on any central authority, such as, a government or bank, to uphold or maintain it. Individual unit (e.g., coin) ownership records are stored in a digital ledger or blockchain, which is a computerized database that uses a consensus mechanism to secure transaction records, control the creation of additional coins, and verify the transfer of coin ownership. Coin ownership can be proved cryptographically. Examples of crypto currency include: Bitcoin, Ethereum, XRP, Dogecoin, Litecoin, etc.

In this description and the following claims, “stablecoin” is defined as a type of crypto currency where the value of units (e.g., coins) is pegged to a reference asset, such as, for example, fiat currency, exchange-traded commodities (e.g., precious metals or industrial metals), other crypto currency, crypto currency portfolios, another stablecoin, etc. In some aspects, a stablecoin is pegged 1:1 to a fiat currency, such as, the U.S. dollar. Examples of stablecoin include: Tether, USD Coin, True USD, USDC, etc.

In this description and the following claims, “non-stablecoin crypto currency” is defined as any crypto currency that is not a stablecoin. Hereinafter, non-stablecoin crypto currency may be referred to simply as “crypto”.

In this description and the following claims, a “currency pair” is defined as a comparison of two different currencies against each other. A currency pair can indicate how much of one currency (fiat, crypto, or stablecoin) is required to buy a unit another currency (fiat, crypto or stablecoin). As such, currency pairs can be utilized to facilitate currency conversions, including conversations between crypto and fiat and vice versa, conversions between stablecoin and crypto and vice versa, conversations between stablecoin and fiat and vice versa, conversions between different stablecoins, conversions between different cryptos, and conversions between different fiats.

In a currency pair, the first currency listed is a base currency (fiat, crypto, or stablecoin) and the second currency listed is a quote currency (fiat, currency, or stablecoin). For example, “EUR/USD” indicates the price of one Euro (the base currency) compared to the U.S. Dollar (the quote currency). EUR/USD=1.10 indicates that 1 Euro can be purchased for 1.10 U.S. Dollars. Similarly, BTC/USD indicates the price of one Bitcoin (the base currency) compared to the U.S. Dollar (the quote currency). BTC/USD=99,579 indicates that one 1 Bitcoin can be purchased for 99,579 U.S. Dollars.

Currencies (fiat, crypto, or stablecoin) may be identified by an ISO currency code or a (e.g., three or four letter) alphabetic code. For example, the alphabetic code BTC identifies the crypto currency Bitcoin, the alphabetic code ETH identifies the crypto currency Ethereum, the alphabetic code USDT identifies the stablecoin Tether, the alphabetic code TUSD identifies the stablecoin TrueUSD, the alphabetic code EUR identifies the fiat currency Euro, etc.

Accordingly, aspects of the invention can utilize currency pairs including a base currency in any of fiat, crypto, or stablecoin and a quote currency in any of fiat, crypto, or stablecoin to facilitate currency conversions. In one example, a currency pair includes a base currency of Tether and a quote currency of Bitcoin (or vice versa). In another example, a currency pair includes a base currency of U.S. Dollars and a quote currency of USD coin (or vice versa). In a further example, a currency pair includes a base currency of Tether and a quote currency of True USD (or vice versa).

In one more specific aspect, an ATS settles a transaction between a buyer paying in crypto and a seller desiring proceeds in fiat. The buyer uses crypto as payment to buy an asset through the ATS. The ATS converts the crypto into stablecoin (e.g., referring to an appropriate Crypto: Stablecoin currency pair or vice versa). Subsequently, the ATS converts the stablecoin to fiat (e.g., referring to an appropriate Fiat: Stablecoin currency pair or vice versa). The ATS sends fiat proceeds of the asset sale to the seller.

In another more specific aspect, an ATS settles a transaction between a buyer paying in fiat and a seller desiring proceeds in crypto. The buyer uses fiat as payment to buy an asset through the ATS. The ATS converts the fiat into stablecoin (e.g., referring to an appropriate Fiat: Stablecoin currency pair or vice versa). Subsequently, the ATS converts the stablecoin to crypto (e.g., referring to an appropriate Crypto: Stablecoin currency pair or vice versa). The ATS sends crypto proceeds of the asset sale to the seller.

The ATS can be configured to handle conversions between multiple different (e.g., M number of) cryptos and multiple different (e.g., N number of) stablecoins. In one aspect, an ATS is also configured to handle conversions between multiple different (e.g., L number of) fiats and multiple different (e.g., N number of) stablecoins. In a further aspect, an ATS is configured to handle conversions between multiple different (e.g., L number of) fiats, multiple different (e.g., M number of) cryptos and multiple different (e.g., N number of) stablecoins. Conversions can also include conversion between different currencies of the same currency type, such as, for example, between different fiats, different stablecoins, different cryptos, etc. The ATS may refer to appropriate currency pairs when converting between currencies.

For example, an ATS settles a transaction between a buyer paying in a first crypto and a seller desiring proceeds in second crypto. The buyer uses the first crypto as payment to buy an asset through the ATS. The ATS converts the first crypto into stablecoin (e.g., referring to an appropriate Crypto 1: Stablecoin currency pair or vice versa). Subsequently, the ATS converts the stablecoin into the second crypto (e.g., referring to an appropriate Crypto 2: Stablecoin currency pair or vice versa). The ATS sends second crypto proceeds of the asset sale to the seller.

In another example, an ATS settles a transaction between a buyer paying in a stablecoin and a seller desiring proceeds in crypto. The buyer uses the stablecoin as payment to buy an asset through the ATS. The ATS either stores the stablecoin or converts the stablecoin to another stablecoin. When converting from one stablecoin to another stablecoin, the ATS can refer to appropriate Stablecoin 1: Stablecoin 2 currency pair or vice versa. Subsequently, the ATS converts the stablecoin or the other stablecoin into the crypto. The ATS sends crypto proceeds of the asset sale to the seller.

As such, aspects of the invention can facilitate various scenario use cases:

Use Case 1: A user buys in crypto (e.g., XRP, Bitcoin, or Eth), that digital currency gets converted into stablecoin (e.g., Tether and/or Circle's USDC) based on the most stable at the time of transaction (ATS to determine and route transaction), converted to Fiat ($USD) for the seller. As described, an ATS can handle any “N” number of stablecoins and “M” number of cryptos.

Use Case 2: A user buys in Fiat ($USD), that fiat currency gets converted into stable coin (e.g., Tether and/or Circle's USDC) based on the most stable at the time of transaction (ATS to determine and route transaction), converted to crypto (e.g., XRP, Bitcoin, or Eth) for the seller.

Use Case 3: The user buys in one crypto (e.g., Bitcoin), and goes through the same process as in Use Case 1, but the seller wants to be paid in another crypto (e.g., XRP).

Accordingly, components of an ATS can take into account various considerations including, but not limited, to a seller wanting to sell digital shares and be paid in fiat ($), a buyer wanting to buy digital shares and pay in crypto (e.g., Bitcoin).

An example transaction flow can include buying an asset in crypto with sale proceeds in fiat. A seller can list shares (e.g., tokens) for sale at an ATS. The seller can link a fiat bank account to a corresponding ATS account (e.g., because they desire proceeds in fiat and would like to withdraw their funds). A buyer identifies the shares (e.g., tokens) for purchase. Buyer links their external crypto currency wallet (because they desire to pay with crypto) to a corresponding ATS account. The external crypto currency wallet may already include or subsequently be funded with crypto.

Buyer buys the shares and selects to pay in crypto. As part of the purchase, the buyer (possibly for a fee) can opt to convert crypto to stablecoin. The ATS accepts the buyers crypto. The ATS converts the crypto to stablecoin (e.g., referencing an appropriate currency pair). Conversion from crypto to stablecoin can occur immediately, essentially in real time, or within a specified time frame of seconds, milliseconds, microseconds, nanoseconds, etc. The ATS can compare stability characteristics of different stable coins and select a more stable (less volatile) stablecoin over some prior historical period (e.g., immediate past as well as recent).

Subsequently, the seller can request proceeds. In response to the seller request, the ATS converts the stablecoin to fiat (e.g., referencing an appropriate currency pair). Conversion from stablecoin to fiat can occur immediately, essentially in real time, or within a specified time frame of seconds, milliseconds, microseconds, nanoseconds, etc. The ATS disburses trade proceeds to the seller in fiat (possibly minus a fee). The ATS moves the shares (e.g., tokens) from the sellers ATS account (reducing the sellers holdings) to the buyers ATS account (increasing the buyers holdings).

The ATS stabilizes the transaction (i.e., reduces transaction volatility) by utilizing stablecoin. As such, the ATS has minimal, and potentially no, net change in value due at least in part to timely, seamless conversion of crypto→stablecoin→fiat.

The ATS can also stabilize transactions (i.e., reduce transaction volatility) of other currency combinations utilizing stablecoin. As such, the ATS has minimal, and potentially no, net change in value due at least in part to timely, seamless conversion of: (1) fiat→stablecoin→crypto, (2) crypto A→stablecoin→crypto B, (3) fiat→stablecoin A→stablecoin B, (4) stablecoin A→stablecoin B→crypto, (5) stablecoin A→stablecoin B→fiat, etc.

Accordingly, aspects of an ATS can be specifically configured and programmed to facilitate transactions using stablecoins. When the ATS performs a transaction, the ATS interacts with each party (e.g., buyer and seller) in their preferred currency. However, in one aspect, the ATS does not inform parties of currencies being used by other parties. As such, each party can interact with the ATS in their preferred currency without knowledge of a currency used by a counterparty. As such, each party may be blind the currency being used by the other party.

Different stablecoin types can have different characteristics. One type of stablecoin may have longer average transaction times compared to another form of stablecoin. There is a need for a technology platform that can create digital securities out of what are known as “real assets” to facilitate the support of multiple forms of crypto, stablecoin, and fiat to widen market reach, broaden customer demographic, and increase the user base. Furthermore, the enhanced flexibility of supporting various forms of crypto, stablecoin, and fiat, while taking into account each currencies associated characteristics to intelligently identify a route and distribution of achieving the buyer's/seller's currency preference, overcomes the inherent risk and volatility of certain cryptocurrencies.

In one aspect, the ATS includes a currency conversion engine. The currency conversion engine can identify an appropriate stablecoin for use in a transaction. The currency conversion engine can identify an appropriate stablecoin, from among a plurality of stablecoins, in essentially real-time based on a collection of factors including, but not limited to: the stability of each stablecoin, the stability of one or more other crypto currencies (e.g., used as backing for a stablecoin), size of the transaction, speed of the transaction, prior relationships, risk factors, chargebacks, KYC, etc. The currency conversion engine ingests relevant coin data for crypto and stablecoin, possibly along with relevant data for fiat currencies. The currency conversion engine also accesses stability derivation parameters. The currency conversion engine utilizes the coin data and derivation parameters to identify an appropriate stablecoin from among the plurality of stablecoins. In one aspect, the identified stablecoin has a requisite stability over time and/or has increased stability over one or more other stablecoins over time.

In another aspect, a coin characteristic module operates separately from the currency conversion engine. The coin characteristic module determines stablecoin characteristics, including stability, on an ongoing basis, at user selected times, in response to events, at defined intervals, etc. The coin characteristic module stores stability, possibly along with other characteristics, in stablecoin records for each of the plurality of stablecoins. The currency conversion engine accesses the stablecoin records when identifying an appropriate stablecoin for use in a transaction. Utilizing stablecoin records alleviates the currency conversion engine from having to perform ongoing, and possibly resource intensive, stablecoin stability calculations at or near the time of a currency conversion. Instead, the coin characteristic module may create, update, and modify stablecoin records during times of reduced resource usage.

During transaction performance, the currency conversion engine can identify an appropriate stablecoin (e.g., on demand and/or through reference to stablecoin records) to utilize for conversions. The currency conversion engine may convert a preferred currency (e.g., crypto) of the buyer to the identified appropriate stablecoin currency to reduce risk in fluctuations in currency valuations. After conversion to the appropriate stablecoin, the currency conversion engine may convert the appropriate stablecoin to the preferred currency (e.g., fiat) of the seller. The currency conversion engine can facilitate any of the other described currency conversion flows.

### Transaction System

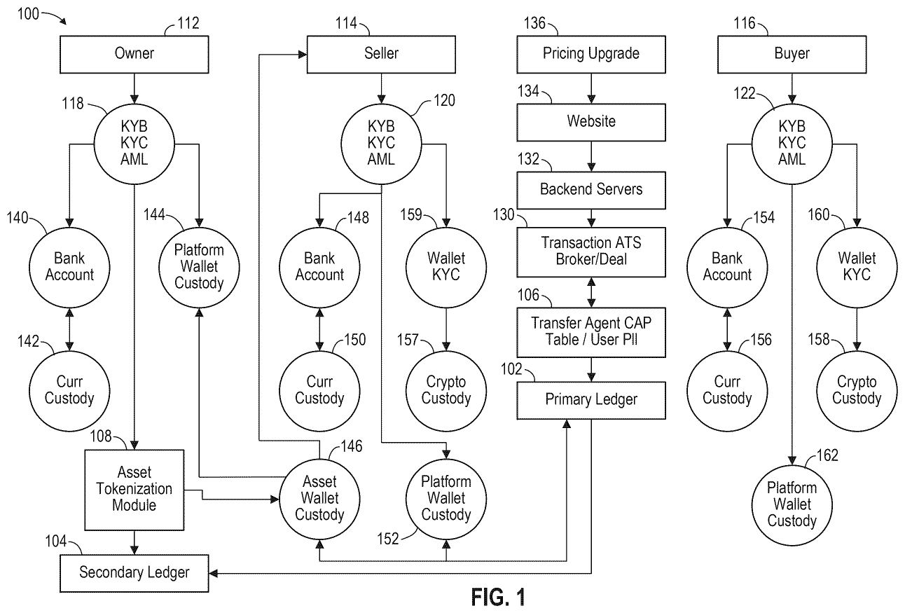

FIG. 1 illustrates an example transaction system 100 (e.g., a digital platform) including semi-redundant ledgers (primary ledger 102 and secondary ledger 104).

In aspects, system 100 is an Alternative Trading System (ATS). System 100 may automatically create and dynamically update (e.g., maintain) capitalization tables of assets underlying exchanged tokens, thereby addressing a long-standing pain point in businesses having investors for whom such capitalization tables must be manually created and revised whenever ownership changes occur. The automatic creation and live syncing maintenance of capitalization tables may facilitate their being continually up to date, complete, verified, and audit-ready (e.g., dynamically updated).

For example, system 100 may provide owners with a list of new investors in a tokenized asset based on the updated capitalization table, reflecting every buyer of the investors'tokens representing an interest in the underlying asset. System 100 may also provide value to the transfer side via improved efficiency and the reduction of manual pain points in their business. The ease and simplicity with which the systems and methods described herein may be applied in practice may provide compelling inducements for industries traditionally slow to adopt new technology, e.g., commercial real estate, to adopt the technology disclosed herein for facilitating transaction processing for the benefit of buyers and sellers of digital assets representing fractional ownership in underlying assets, system 100, sponsors of investments in assets and/or owners of assets (e.g., real estate) may provide access to investments in such assets which may have previously been unavailable, for example, due to securities regulations and/or rules defining sophisticated and accredited investors.

Retail investors and buyers of assets have traditionally been locked out of participating in commercial real estate investments because they lack the minimum investment threshold and/or do not have sufficient qualifications as traditional investors to acquire an interest in an asset from a Seller of the interest in the asset. System 100 may establish an exchange (primary or secondary) via which the asset tokens are exchanged in trades, following any holding periods following the primary issuance of securities underlying the asset tokens as may be required by securities regulations (e.g., Rule 144), so the restrictions of the securities regulations pertaining to qualifications of the investors may not apply to the contemplated exchange of asset tokens. For example, system 100 may unlock real estate investment opportunities for retail buyers, not only facilitating retail buyers to capture return on investment, but also to take advantage of potential tax savings, for example, via write-offs of depreciation of the underlying assets on tax returns.

The disclosed technology can create digital securities out of what are known as “real assets” and can function as a (primary or secondary) market platform or Financial Exchange for these types of assets as well as for other types of assets such as, but not limited to, investments in real estate, investments in franchises, investments in business that generate dividends or returns based on performance of the business or underlying asset, investments in ventures that capture or mine natural resource such as, but not limited to uranium, timber, and other commodities, private credit, private debt, intangible assets, tradeable assets, and any other types of appropriate assets.

As depicted, system 100 includes owner 112, seller 114, and buyer 116. Each of owner 112, seller 114, and buyer 116 may include computing and communication resources and systems (e.g., an owner device, a seller device, and a buyer device, respectively) corresponding to and/or representing users interfacing with system 100. Owner 112 may be an owner of an asset listed on the transaction platform and/or a sponsor of investments in an asset listed on the transaction platform, and may also be referred to as an asset owner or a property owner.

Seller 114 may represent one who is selling or listing an asset as available for sale or exchange, e.g., available to be transferred to another user in exchange for something else (e.g., tokens, currency, etc.). Seller 114 may also be referred to as a seller when participating in a buy-sell transaction, for example.

Buyer 116 may represent one who is seeking to purchase, buy, or acquire at least a partial interest in an asset which is listed (e.g., as available for sale or exchange) on the transaction platform. Buyer 116 may also be referred to as a buyer when participating in a buy-sell transaction, for example.

System 100 may perform verification of identification and related information for each of the users of the system 100 (e.g., including owner 112, seller 114, and/or buyer 116) via an online identity verification process, for example, a know your customer (KYC) verification process for an individual user, a know your business (KYB) verification process for any business entity, such as, but not limited to, limited liability company (LLC), C corporation, S corporation, and other appropriate business entities, and/or an anti-money laundering (AML) verification process.

System 100 provides mechanisms for transmitting and/or receiving transfer of various fiat, crypto, and stablecoin currencies as well as other digital content and digital assets, (e.g., digital bits and/or bytes storable in a computer-readable memory of the system 100) over a computing communication system associated with the system 100. Each user of system 100 may have a user account at system 100. Each user can digitally/electronically link their user account at system 100 to one or more computer-networked external financial accounts. The financial accounts can be a source for funding purchases and/or a location to receive proceeds. System 100 can use digital, electronic, and/or computer-networked communication to withdraw from and deposit to financial accounts. In one aspect, user accounts at system 100 include internal financial accounts linked to the corresponding external financial accounts. For example, a user of system 100 can have internal account for USD linked to an external bank account for USD. Similarly, a user of system 100 can have an internal account for BTC linked to an external BTC wallet.

Generally, per user, system 100 can include linkages between a variety of different internal financial accounts and corresponding external financial accounts, including any of: fiat accounts, crypto accounts, and stablecoin accounts. Accounts can include, but are not limited to: financial institution accounts, bank accounts, credit union accounts, investment accounts, crypto accounts, crypto wallets, stablecoin wallets, digital asset wallets, other provider or recipient of digital currency representations and/or digital assets associated with a transaction processed by system 100, etc.

As such, a buying party to transaction can utilize any of fiat, crypto, or stablecoin for an asset purchase. Similarly, a selling party to a transaction can utilize any of fiat, crypto, or stablecoin to receive proceeds. In some embodiments, the asset bought/sold in a transaction is a digital asset. Digital assets may include, but are not limited to: crypto, stablecoin, crypto tokens, crypto coins, security tokens, asset tokens, non-fungible tokens (NFTs), fungible tokens, and/or other appropriate forms of digital assets. Thus, in some aspects, one form of digital asset is used to purchase another form of digital asset or proceeds for sale of a digital asset are transferred to a seller in the form of another digital asset. For example, cypto can be used to purchase a token representing a share in an apartment building. In another aspect, proceeds of the sale of a token representing a share in a franchise are transferred to a seller in stablecoin.

Accordingly, a buy/sell transaction implemented at system can include: (1) some amount of a buyer side currency type selected from among fiat, crypto, or stablecoin, (2) a subject asset, and (3) some amount of a seller side currency type selected from among fiat, crypto, or stablecoin. In aspects, the subject asset is any of the described digital assets.

Thus, in some aspects, (and in addition to trading tokens representing fractionalized interests in real assets) system 101 can perform currency trading utilizing various internal and/or external financial accounts of a buyer and of a seller. For example, a buyer can utilize an amount of a first form of crypto (buyer side currency type) to purchase an equally valued amount of a second form of crypto (subject asset) from a seller. However, the seller may desire proceeds of the sale in fiat or stablecoin (the seller side currency type). The buyer can receive the amount of the second form of crypto in exchange for the amount of the first form of crypto. The seller can receive an equally valued amount of fiat or stablecoin as proceeds in exchange for the amount of the second form of crypto.

In another example, a buyer can utilize an amount of fiat (buyer side currency type) to purchase an equally valued amount of a first form of crypto (subject asset) from a seller. However, the seller may desire proceeds of the sale in a second form of crypto or stablecoin (the seller side currency type). The buyer can receive the amount of the first form of crypto in exchange for the amount of fiat. The seller can receive an equally valued amount of a second form of crypto or the stablecoin as proceeds in exchange for the amount of the first form of crypto.

Sending and/or distributing fees and/or funds, receiving and/or collecting fees and/or funds, and exchanging (e.g., digital) assets for fees and/or funds as described herein are merely illustrative examples of the technological systems and methods which may be applied in addressing challenges in a variety of other contexts and applications, also. For example, the technological systems and methods described herein may provide novel systems and methods for transmitting and/or receiving transmissions of various types of digital content and/or digital assets (e.g., digital bits and/or bytes storable in a computer-readable memory of the system 100) over a computing communication system associated with the system 100.

In various non-limiting examples, including those described herein, the digital content and/or digital assets transmitted and/or received by components of the system 100 and corresponding methods described herein may include digital representations of currency, crypto, stablecoin, NFTs, and/or digital assets such as written works, artwork, photographs, audio/video programs, music, digital blueprints, computer-aided design (CAD) files representing physical articles of manufacture, architectural designs, plats of survey, deeds to real property, stock and/or membership interests in business entities, tokens representing stock and/or interests in digital or real assets, executed contracts, ownership and/or membership interests in timeshare properties, co-op properties, travel/vacation clubs, recreational clubs, social clubs, etc. Additional examples of content could be valuation estimates, third party appraisals, proof of purchases, copies of insurance policies, profit and loss data, calendars and schedules, and performance data.

As depicted, system 100 includes primary ledger 102 (e.g., a private mutable ledger), secondary ledger 104 (e.g., a public immutable ledger), transfer agent 106, asset tokenization module 108, backend servers 132, website 134, and pricing oracle 136. While primary ledger 102 and transfer agent 106 are depicted as separate, it should be understood that, in certain aspects, primary ledger 102 and transfer agent 106 are included within the same service. The users may interact with website 134 via a web browser app executing on computing devices of owner 112, seller 114, and buyer 116, all of which can be, but is not limited to, a desktop computer, laptop computer, tablet computer, personal digital assistant (PDA), cell phone, mobile phone, smart phone, and/or other computing devices including mobile devices.

Website 134 can transfer user-interface data to and/or from computing devices corresponding to owner 112, seller 114, and buyer 116. Web browser apps at computing devices corresponding to owner 112, the seller 114, and the buyer 116 can process the user-interface data and present a corresponding user-interface. The user-interface data and user-interfaces can be tailored per user based on how a user is participating in a transaction, such as, for example, as an owner, a seller, or a buyer. For example, a seller and a buyer may get different user-interfaces, one user-interface with data relevant to selling a fractional interest in an asset and another user-interface with data relevant to purchasing the fractional interest in the asset respectively.

System 100 may be communicatively coupled with transaction ATS broker/dealer module 130, pricing oracle 136, and secondary ledger 104. While, in some aspects, primary ledger 102 is described as being centralized and secondary ledger 104 as being decentralized (e.g., distributed), it should be understood that primary ledger 102 could be decentralized. Primary ledger 102 and/or secondary ledger 104 may be implemented with blockchain technology. Primary ledger 102 and secondary ledger 104 may be private or public. Primary ledger 102 and secondary ledger 104 may include multiple copies of ledgers maintained on different computing nodes of computing networks implementing and/or supporting one or more public blockchain protocols, for example, but not limited to, Ethereum, Bitcoin, Binance Smart Chain (BSC), Cardano, Polkadot, Solana, Chainlink, Cosmos, TRON, HIVE, Polygon (Matic Network), and more.

In certain aspects, primary ledger 102 can store user personally identifiable information (PII) utilized by the system 100, as well as a capitalization table (also referred to as a cap table). The capitalization table maintains the status of platform assets and transactions, including the capitalization of each asset (e.g., real property) listed on the platform (e.g., listed as available for transactions on the platform). Primary ledger 102 may be implemented as a Structured Query Language (SQL) or other database, for example.

In some aspects, primary ledger 102 is maintained by transfer agent 106. The function of transfer agent 106 may be unregulated. Transfer agent 106 can record transactions and/or transaction data in primary ledger 102. Transactions and/or transaction data in primary ledger 102 can be (e.g., automatically) semi-redundantly synchronized to secondary ledger 104. For example, transfer agent 106 can (e.g., semi-redundantly) synchronize primary ledger 102 and secondary ledger 104. In some aspects, semi-redundant synchronization occurs automatically in accordance with synchronization rules, such as, for example, removing PII prior to synchronization. Further, transfer agent 106 may act as a gatekeeper and share information regarding transactions on primary ledger 102 and/or secondary ledger 104 only with authorized users and/or transaction ATS broker/dealer module 130.

In combination, primary ledger 102 and/or secondary ledger 104 can be utilized to automatically and digitally preserve evidence of transaction completion. Upon transaction completion (e.g., settlement), transaction related data can be (automatically) recorded to primary ledger 102 (e.g., a private mutable ledger). At least a subset of the transaction related data can be semi-redundantly (and automatically) synchronized from primary ledger 102 to secondary ledger 104 (e.g., a public immutable ledger, such as, a block chain).

Transaction ATS broker/dealer module 130 may include computing and communication resources and systems corresponding to and/or representing a registered broker, registered dealer, registered broker/dealer licensed by the US Securities and Exchange Commission (SEC), the Financial Industry Regulatory Agency (FINRA), other domestic/international regulatory or governmental agencies, and/or similar roles in various exemplary applications and/or jurisdictions in which the system 100 is utilized. Transaction ATS broker/dealer module 130 may interface with the system 100 to provide associated broker/dealer functionality on system 100.

Functionality provided by the transaction ATS broker/dealer module 130 may be separate from functionality provided by other modules of system 100, for example, due to regulatory requirements including those promulgated by the Financial Industry Regulatory Authority (FINRA). In one aspect, transaction ATS broker/dealer module 130 may include an Alternative Trading System (ATS) and implementations (e.g., software, firmware, programmable logic arrays, electronic circuitry, etc.) of FINRA-compliant processes and methods for facilitating the transactions processed by the transaction platform as approved and licensed by FINRA.

In one aspect, ATS broker/dealer module 130 also includes conversion components (e.g., a currency conversion engine, a coin characteristic module, etc.) facilitating currency conversions in accordance with any of the described currency conversion flows.

The conversion components can determine an appropriate stablecoin currency available based on a collection of factors including, but not limited to: the stability of each digital currency, size of the transaction, speed of the transaction, prior relationships, risk factors, chargebacks, and KYC. The conversion components communicate with backend servers 132 to provide respective amounts of crypto currency, stablecoin, or fiat required for a transaction. The conversion components may include a coin characteristic module that derives stablecoin characteristic that are in turn utilized to determine stablecoin stability. The conversion components may also communicate with the transaction ATS broker/dealer 130 to obtain applicable rules to be used in the determination of an appropriate stablecoin and currency conversion flow. There may be rules or regulations prohibiting certain currencies for a respective transaction. For example, an asset class may be restricted in the currencies available for transaction based on certain regulations and requirements. There may also be regional considerations. For instance, if a state opts out of certain agreements, then they would be restricted from certain transactions and currencies.

Functionality provided by transaction ATS broker/dealer module 130 may be implemented in a virtual private cloud separate from other modules of system 100. Firewalls may be established for transaction ATS broker/dealer module 130 to be separate from and/or on a separate web services instance than other modules of system 100. Transaction ATS broker/dealer module 130 may provide functionality to introduce buyers 116 and sellers 114 to each other, to present user-interfaces, to allocate resources, to release allocated resources, to generate smart contracts, to settle transactions facilitated by system 100, to convert currencies, to determine coin characteristics, to distribute fees associated with the transactions facilitated by the transaction platform to appropriate participants in system 100, and/or to act as a gatekeeper of transactions facilitated by the transaction platform.

Smart contracts are digital contracts that automatically execute, control or document events and actions according to the terms of a contract or an agreement. Fees generated from activities on system 100 during an acquisition/transfer transaction (e.g., buy-sell transaction, acquisition transaction, merger transaction, etc.) may be collected and/or distributed by transaction ATS broker/dealer module 130, for example, according to rules, agreements, and/or smart contracts associated with the transaction facilitated by the transaction platform. Fees generated from activities and/or participants of system 100 outside transaction ATS broker/dealer module 130 (e.g., from other participants of the transaction platform and/or any third-party system that is not included in system 100) may be processed and collected by components of system 100.

Transaction ATS broker/dealer module 130 may request payment of fees (e.g., fees associated with a transaction facilitated by components of system 100) via third-party custody account(s) of the buyer 116. Transaction ATS broker/dealer module 130 may deduct funds sufficient to cover the fees from proceeds of the transaction to pay seller fees (e.g., fees payable to the seller 114) as stipulated by and/or agreed to by the seller 114 in a smart contract associated with the transaction as part of a process of listing a token as available for an exchange transaction facilitated by system 100.

A computing system of the third-party custody account(s) may send funds to cover the fees to transaction ATS broker/dealer module 130 at which time transaction ATS broker/dealer module 130 may keep the funds covering the fees. Transaction ATS broker/dealer module 130 may disburse funds covering a licensing fee for system 100 to one or more entities due those fees. Transaction ATS broker/dealer module 130 may disburse funds covering a partnership fee to the transfer agent 106. Transaction ATS broker/dealer module 130 may generate and/or distribute a final settlement statement to the buyer 116 and seller 114. In the event of any errors, omissions, glitches, or problems associated with the transaction processed by system 100, transaction ATS broker/dealer module 130 may notify a designated third party of the event for appropriate remediation. Transaction ATS broker/dealer module 130 may include one or more maintenance and support modules via which remediation, updates, upgrades, and/or support may be provided via a third-party computing system communicatively coupled with transaction ATS broker/dealer module 130.

Fees may be converted between and/or transferred to and/or from accounts in any of the described currencies.

Pricing oracle 136 may include a third-party service that connects smart contracts formulated in system 100 with third-party entities and third-party systems outside of system 100. Pricing oracle 136 may provide a user of system 100 with an estimate of the current value of an asset. Pricing oracle 136 may facilitate calculations and computations based on the estimate as directed by the user. The user may modify inputs to pricing oracle 136 to utilize pricing oracle 136 for determining the user's own market pricing estimates. For example, buyer 116 may modify inputs to pricing oracle 136 to utilize pricing oracle 136 for estimating a future value of their investment in an asset and determining an amount of funds buyer 116 may agree to exchange for the asset on a given day. Seller 114 may transmit information indicating agreement with pricing data provided by pricing oracle 136, or seller 114 may transmit information that overrides the pricing data provided by pricing oracle 136. For example, in the context of commercial real estate assets, pricing oracle 136 may include a digital broker opinion of value (BOV).

In an example, owner 112 (e.g., a real estate property owner) may authenticate with system 100 according to KYB KYC AML 118 protocols and methodologies. Owner 112 may link bank account 140 and currency custody module 142 to system 100. Currency custody module 142 may serve as a custodian for owner 112's currency on system 100. Currency custody module 142 may be configured to hold fiat currency, for example, US dollars ($) or other forms of fiat currency. Optionally, or concurrently with linking bank account 140 and currency custody module 142, owner 112 may link a crypto wallet and crypto custody module to system 100. The crypto custody module may serve as a custodian for owner 112's crypto on system 100. The crypto custody module may be configured to hold crypto, for example, Bitcoin (BTC) or other forms of crypto. Platform digital wallet custody module 144 may serve as a custodian for owner 112's digital assets on system 100, such as, for example, tokens representing ownership interests in businesses, tokens representing ownership interests commercial real estate, etc.

In the example, seller 114 may authenticate with system 100 according to KYB KYC AML 120 protocols and methodologies. In some examples, owner 112 and seller 114 may be the same individual or entity playing the different roles in a transaction, while in other examples, owner 112 and seller 114 may be different individuals or entities, for example, if seller 114 is a broker or agent engaged by owner 112 to list and/or transfer the property on system 100 on their behalf. Seller 114 may link bank account 148 and currency custody module 150 to system 100. Currency custody module 150 may serve as a custodian for seller 114's fiat currency on system 100.

Crypto custody module 157 may serve as a custodian for seller 114's crypto currency on system 100. Crypto custody module 157 may be configured to hold crypto currency, for example, Bitcoin (BTC), USDC, or other forms of crypto currency including other stablecoin. Crypto custody module 157 may authenticate with system 100 according to wallet KYC 159 protocols and methodologies. Crypto custody module 157 may also include functionality and/or an interface to convert or exchange crypto currency held thereby into fiat currency or different crypto currency (including stable coin) for the benefit of seller 114. Crypto custody module 157 can interoperate with a currency conversion engine and/or a coin characteristics module (potentially included in transaction ATS broker/dealer 130) to facilitate crypto currency conversions or exchanges. Conversions or exchanges of the crypto currency held by digital wallet custody module 157 to fiat currency or other crypto currency may be documented by a transaction entry in primary ledger 102 and/or secondary ledger 104.

Platform digital wallet custody module 152 may serve as a custodian for seller 114's digital assets on system 100, such as, for example, tokens representing ownership interests in businesses, tokens representing ownership interests commercial real estate, etc. Platform digital wallet custody module 152 can serve as custodian for digital assets which seller 114 transfers on behalf of a separate owner (e.g., via a broker or agency relationship) and the digital assets which seller 114 transfers on its own behalf as also owner 112 of the digital assets.

Asset tokenization module 108 may generate one or more digital assets, for example, tokens, representing fractional ownership in an asset and/or a value of an asset, for example, a real estate property owned by owner 112, and store the generated digital assets (e.g., tokens) in asset wallet custody module 146. Asset wallet custody module 146 may transmit data to and/or recording generation of digital assets (e.g., tokens) at primary ledger 102 and/or secondary ledger 104. Asset wallet custody module 146 may transmit the digital assets (e.g., tokens) to owner 112's platform digital wallet custody module 144 and provide data to transfer agent 106 to record in the primary ledger 102 regarding the creation and/or transfer of the digital assets (e.g., tokens) generated by asset tokenization module 108. Data recorded to primary ledger 102 can be (e.g., automatically) semi-redundantly synchronized to secondary ledger 104.

Asset wallet custody module 146 may transmit an invitation to seller 114 to claim the digital assets (e.g., a token representing a fractional interest in a real asset) generated by asset tokenization module 108. When seller 114 claims or retrieves its associated portion of the digital assets generated by asset tokenization module 108 that is stored in asset wallet custody module 146, for example, if seller 114 is going to trade its associated portion of the digital assets generated by asset tokenization module 108 on system 100, then asset wallet custody module 146 may transmit the digital assets to seller 114's platform digital wallet custody module 152 and transmit information regarding the transfer to transfer agent 106 for recording on the primary ledger 102 (with, for example, automatic, semi-redundant synchronization to secondary ledger 104). In some aspects, instead of transmitting an invitation to seller 114, asset wallet custody module 146 can transmit the digital assets generated by asset tokenization module 108 directly to seller 114's asset wallet custody module 146.

In an example, buyer 116 may authenticate with system 100 according to KYB KYC AML 122 protocols and methodologies. Buyer 116 may link bank account 154 and currency custody module 156 to system 100. Currency custody module 156 may serve as a custodian for buyer 116's fiat currency on system 100.

Crypto custody module 158 may serve as a custodian for buyer 116's crypto currency on system 100. Crypto custody module 158 may be configured to hold crypto currency, for example, Ethereum (ETH), Tether, USDC, or other forms of crypto currency including other stablecoin. Crypto custody module 158 may authenticate with system 100 according to wallet KYC 160 protocols and methodologies. Crypto custody module 158 may also include functionality and/or an interface to convert or exchange the crypto currency held thereby into fiat currency or different crypto currency for the benefit of buyer 116. Crypto custody module 158 can interoperate with a currency conversion engine and/or a coin characteristics module (potentially included in transaction ATS broker/dealer 130) to facilitate crypto currency conversions or exchanges. Conversions or exchanges of the crypto currency held by crypto custody module 158 to fiat currency or other crypto currency may be documented by a transaction entry in primary ledger 102 and/or secondary ledger 104.

Platform digital wallet custody module 162 may serve as a custodian for buyer 116's digital assets on system 100, for example, such as, for example, tokens representing ownership interests in businesses, tokens representing ownership interests commercial real estate, etc. Tokens in platform digital wallet custody module 162 may have previously been generated by asset tokenization module 108 and represent fractional interests in assets, such as, for example, real assets.

In an example, buyer 116 may see (e.g., in a presented user-interface) that seller 114 has listed one or more digital assets (e.g., one or more tokens each representing a fractional interest in a real asset) for sale. The one or more digital assets may have been generated by asset tokenization module 108, transferred through asset wallet custody module 146, and stored in platform custody wallet 152. In one aspect, the one or more digital assets are listed on website 134 that is accessed by buyer 116.

Buyer 116 can engage in a transaction to purchase the one or more digital assets. The transaction can be processed by system 100 to exchange fiat currency via currency custody module 156 and/or crypto via crypto custody module 158 for the one or more digital assets (e.g., the one or more tokens each representing a fractional interest in a real asset). Seller 114 may receive fiat currency from currency custody module 156 into currency custody module 150 and/or crypto from crypto custody module 158 into crypto custody module 157. Buyer 116 may receive the one or more digital assets from platform digital wallet custody module 152 into platform digital wallet custody module 162. Evidence regarding the transfer and settlement of the transaction can be transmitted to and recorded on primary ledger 102 as well as on secondary ledger 104. In one aspect, data is recorded on primary ledger 102 and subsequently semi-redundantly synchronized to secondary ledger 104.

In aspects, one or more of website 134, backend servers 132, transaction ATS broker/dealer 103 and transfer agent 106 interoperate with one another as well as with relevant currency accounts, currency wallets, currency custody modules, platform digital wallet modules, etc. to perform and settle a transaction. The one or more of website 134, backend servers 132, transaction ATS broker/dealer 103 and transfer agent 106 can interoperate transferring a digital asset (e.g., a token representing a fractional ownership interest) between platform digital wallet modules and transferring currencies between relevant custody modules (e.g., fiat, crypto currency, etc.).

Thus, in aspects, crypto currency custody modules and/or (fiat) currency custody modules interoperate with a currency conversion engine internal to and/or spanning website 134, backend servers 132, transaction ATS broker/dealer 103 and transfer agent 106. The currency conversion engine facilitates crypto based transactions in a manner that mitigates risk associated with crypto volatility. As such, system 100 may provide functionality to shield and insulate buyers and sellers from the preferred currency of a counter party. However, exchanges of one cryptocurrency to another cryptocurrency, or fiat may not happen instantaneously. Due at least in part to the delay in exchange, a crypto value at the time a buyer agrees to purchase a digital asset can (potentially drastically) differ from the crypto value at the time of exchange. The conversion engine can convert the buyer's crypto to an appropriate stablecoin, which is then subsequently converted to the seller's preferred currency (e.g., another crypto or fiat). Conversion to and/or from stablecoin significantly reduces currency volatility relative to crypto.

In one example, buyer 116 and seller 112 agree to a transaction transferring a digital asset (e.g., a token representing a fractional ownership interest) currently held in platform digital wallet custody module 152 from seller 112 to buyer 116 for an agreed to price. Buyer 116 may prefer crypto (e.g., XRP, Bitcoin, Etheruem, etc.) and seller 112 may prefer fiat (USD). Website 134 can present the sale price to buyer 116 in crypto and can present the sale price and/or resulting proceeds to seller 112 in fiat.

Buyer 116 initiates payment for a digital asset using an amount of crypto. The amount of crypto is transferred from crypto custody module 158 to the currency conversion engine. The currency conversion engine identifies an appropriate stablecoin using any of the described mechanisms. The conversion engine, potentially through reference to a corresponding currency pair, converts the amount of crypto to an equally valued amount of the appropriate stablecoin. Subsequently, the conversion engine, potentially through reference to another corresponding currency pair, converts the amount of stablecoins to an equally valued amount of fiat. The amount of fiat is transferred to conversion engine into currency custody module 150. The digital asset is transferred from platform digital wallet custody module 152 to platform digital wallet custody module 162. When appropriate, relevant fees (e.g., conversion fee, service fee, etc.) can be taken from the sale price in a currency preferred by system 100 prior to transferring trade proceeds to currency custody module 150.

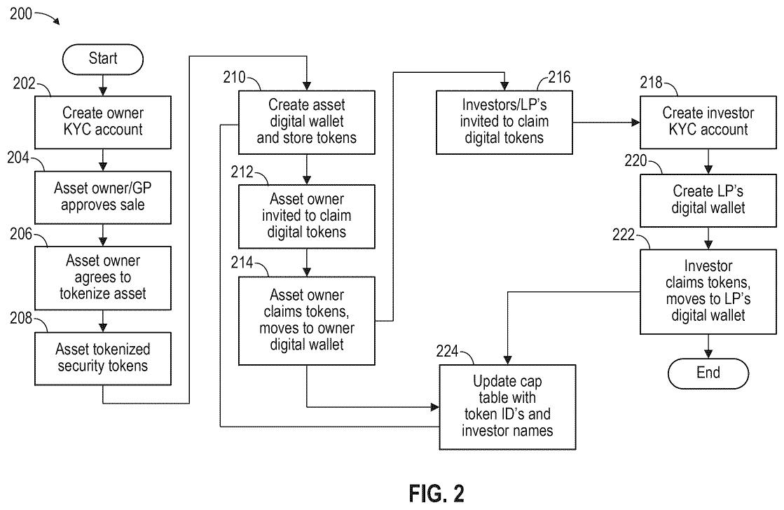

FIG. 2 illustrates an exemplary process 200 for tokenization of an asset, according to some aspects of the disclosed technology. Process 200 can be implemented using the components of system 100. For example, one or more tokens can be created, each token representing a fractional interest in an asset. There are at least two types of participants in process 200. One is an owner, (e.g., an asset holder), such as the owner 112, who may also be referred to as a sponsor or general partner (GP). The other is an investor, also referred to as a limited partner (LP). The investor may be a current investor in the asset or an investor who wants to invest in the asset. The investor may also be referred to as the buyer, such as buyer 116.

Initially (e.g., at or prior to “START”), the participants (e.g., users) may be onboarded with system 100 as discussed with reference to FIG. 1, and process 200 that the participants undergo to become onboarded with system 100 is described in detail below. For example, the owner (e.g., may be GP) may undergo a KYB process and a KYC account for owner 112 may be created with system 100 (operation 202). Owner 112 may approve sale of the asset using the system 100 (operation 204) to generate a smart contract memorializing agreement to sell and list.

After owner 112 agrees to tokenize (fractionalize interests in) an asset (operation 206), system 100 may tokenize the asset as security tokens (operation 208), for example, or as other digital assets including, but is not limited to, nonfungible tokens (NFTs), fungible tokens, hybrid tokens, crypto currencies, crypto tokens, crypto coins, security token, and asset tokens, having metadata including identification information of the buyer of the NFTs. The security tokens may include, for example, ERC 1400 tokens. The security tokens may be fungible tokens or non-fungible tokens, which are unique and differentiated from other tokens representing a share of value in the asset, and may store associated meta data. In various examples, other digital asset types may be used. The security tokens created may include tokens designated as being owned by the GP and tokens owned by each of the investors or LPs who also hold an interest in the asset.

In the example of FIG. 2, an asset having a net value of $1,000,000 may be tokenized as 1,000 tokens, each token having a value of $ 1,000. In this example, the net value of the asset may be taken into account any debt by which the asset is burdened. In other words, an asset having a market value of $2,000,000, and a mortgage securing a debt of $1,000,000 recorded as a lien against the asset, may have a net value of $1,000,000. An asset having a market value of $1,000,000, and no debt against the asset, may have a net value of $1,000,000.

These tokens may be sent by transfer agent 106 to a platform digital wallet, such as platform digital wallet custody module 152, created for the asset (operation 210), and the capitalization table for the asset may be updated by transfer agent 106 to reflect moving the tokens (operation 224). An identification number (ID) identifying the unique tokens may be included in the capitalization table along with the token's owner or investor's identification information. The platform digital wallet may be held by system 100 or a third party.

System 100 may invite the GP to claim the tokens (operation 212). When the GP claims the tokens, they may be moved from the platform wallet to the GP's digital wallet (operation 214), and the capitalization table may be updated to reflect the move (operation 224). The tokens claimed by the GP are only the GP's tokens, not investors'(LP's) tokens. The GP may then invite the investors (LPs) to claim their tokens (operation 216). Once the LPs claim their tokens, the LPs may be free to conduct transactions on system 100 using the tokens, for example, transferring their tokens or exchanging their tokens for other items of value, for example, other tokens representing interests in other assets.

If an LP who wishes to claim their tokens is not registered or onboarded onto system 100, the LP may undergo a KYC process to create an investor account with the platform on the system 100 (operation 218) and create the LP's digital wallet (operation 220). The LPs may then claim their tokens, which may then be moved from the platform asset digital wallet (which may have been holding the tokens since they were created in operation 208) to the LP wallets (operation 222), and the capitalization table may be updated to reflect the moves (operation 224). For example, the capitalization table may associate the token identifiers (IDs) with the names of the LPs.

When the capitalization table is updated (operation 224), system 100 can record the updated capitalization table may be updated in primary ledger 102 and/or secondary ledger 104 (blockchain). In one aspect, system 100 records an updated capitalization table to primary ledger 102. The system 100 may also automatically update (e.g., semi-redundantly synchronize) secondary ledger 104 to correspond with primary ledger 102. PII about the GP or LPs may be withheld from and not stored in secondary ledger 104. For example, instead of an LP name, the secondary ledger may associate token IDs with a hash value that is unique to the LP. In this manner, a blockchain transaction at secondary ledger 104 may be linked to the LP, while the LP may remain anonymous. The primary and secondary ledgers 102, 104 may be correlated using a database within system 100.

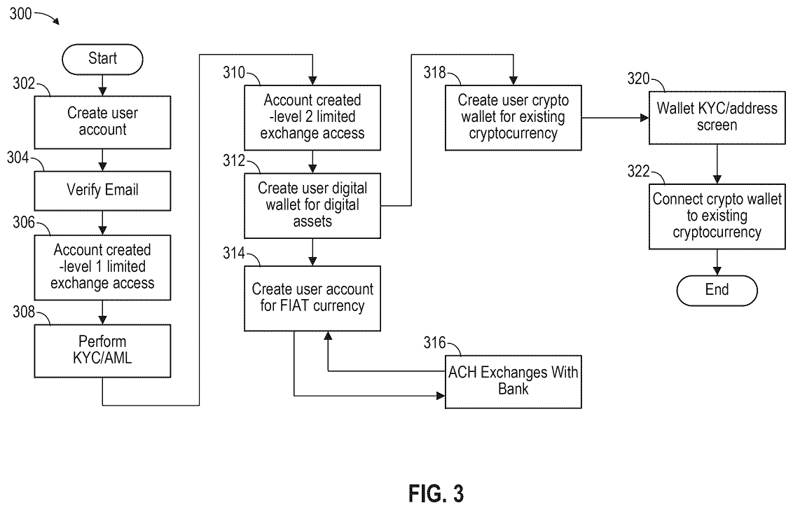

FIG. 3 illustrates an exemplary process 300 for user (e.g., owner 112, seller 114, or buyer 116) onboarding and account creation, according to some aspects of the disclosed technology. Process 300 can be implemented using the components of system 100. For a new user, e.g., the owner 112, seller 114, or buyer 116, system 100 may first perform a light account creation with the user's name, email address, and password (operation 302). System 100 may then verify the user's email address (operation 304), for example, by emailing a verification link to the user's email address, which the user may click or follow to verify the user's email address with the platform.

After successful email verification, system 100 may perform a level 1 account creation for the user (operation 306). The level 1 account may provide limited access to system 100, for example, authorizing the user to browse tokenized assets, but not to acquire or exchange the tokens created to represent the tokenized assets.

A user may gain level 2 access by successfully completing the KYB/KYC/AML process (operation 308). System 100 may create a level 2 access account for the user to provide the user with full exchange access (operation 310), which may include all access of the level 1 access plus full access to the exchange, for example, authorizing the user to acquire and/or exchange tokens created to represent tokenized assets. Upon successful completion of the KYB/KYC/AML process, system 100 may also allocate computing resources (e.g., system memory resources, storage resources, network resources etc.) for the creation of digital wallets. Using the allocated computing resources, system 100 can create multiple digital wallets or financial holdings accounts for the user. Level 2 account creation can include a user indicating one or more desired (or preferred) currencies (e.g., crypto, fiat, stablecoin) to use for transaction settlement when participating in transactions at system 100.

For example, system 100 can create a digital wallet (e.g., 144, 152, 162, etc.) to hold digital assets, such as, tokens representing fractional ownership interests (operation 312), a fiat account to hold fiat currency (e.g., 142, 150, 156) (operation 314), and a crypto currency wallet to hold crypto currency (operation 318). The user's digital wallet can be used to receive, transmit, hold, etc. tokens (e.g., asset tokens representing fractional interests in an asset) generated by system 100 and from/to other user digital wallets at system 100. The user's crypto currency wallet may receive and/or transmit crypto currency from/to crypto currency wallets and/or accounts off system 100.

The user's fiat account can be used to receive and/or transmit fiat from/to digital fiat accounts/currency wallets and/or accounts off of system 100. The user may fund the user's fiat account, for example, via an ACH transfer or ACH exchange with a bank or other financial institution (operation 316). The user may also transfer fiat currency from the user's fiat account on system 100 to a bank or other financial institution external to the system 100 via an ACH transfer (operation 316).

The user's crypto currency wallet can be used to receive and/or transmit crypto from/to crypto accounts/crypto currency wallets and/or accounts off of system 100. The user may fund the user's crypto currency wallet, for example, via appropriate digital transfers. The user may also transfer crypto currency from the user's crypto currency wallet on system 100 to external crypto wallets or other crypto accounts external to the system 100 via approbative digital transfers (operation 316).

Such a user may first successfully complete a wallet know-your-customer (KYC) process, such as a security process, and address screen (operation 320) to ensure the authenticity and security of the user's existing cryptocurrency. System 100 may then connect the crypto currency wallet to an external cryptocurrency digital wallet for the user (operation 322) based on determining that the authenticity and security are proper. The user may then transfer cryptocurrency from an off-platform crypto currency wallet to the user's on-platform crypto currency wallet. In certain aspects, the security process is continually monitoring the crypto currency wallet to determine proper authenticity and security.

A level 2 account may grant a user privileges to participate in transactions to acquire, sell, and exchange tokens on system 100. As part of transactions, currency (crypto, stablecoin, fiat) can be transferred between relevant currency custody modules and converted and tokens transferred between platform digital wallet custody modules 152.

In some aspects, the user's account(s) on the system 100 may earn dividends, and the earned dividends may be moved into the user's fiat account when in the form of fiat currency or into the user's crypto currency wallet when in the form of a cryptocurrency. Note that on system 100, asset tokens may be purchased by and/or sold for any or a variety of different forms of fiat currency and/or crypto currency, or combinations thereof. Likewise, in such aspects, the dividends may be earned and paid to a user's account in a variety of different forms of fiat currency and/or cryptocurrency, or combinations thereof.

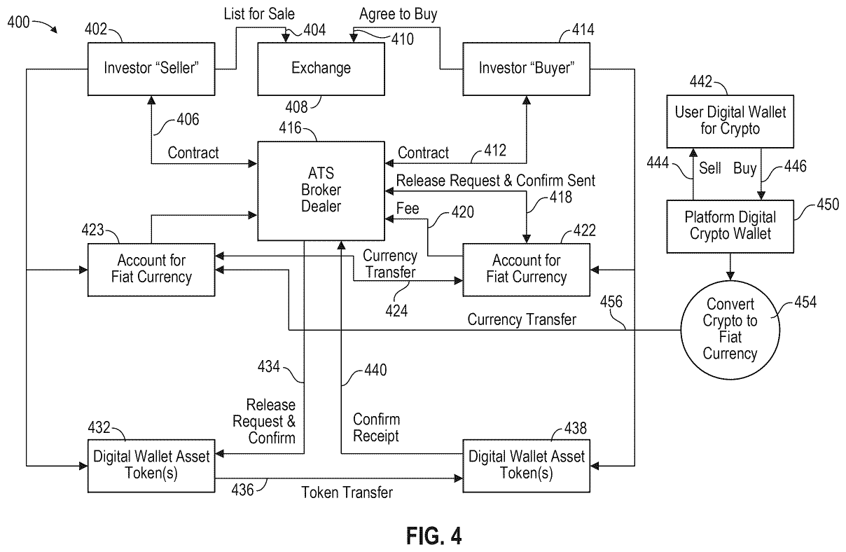

FIG. 4 illustrates an exemplary process 400 for acquiring and transferring asset tokens without intermediate currency conversion through stablecoin, according to some embodiments of the disclosed technology. Process 400 can be implemented using the components of system 100. A first investor (illustrated at block 402), referred to herein as the “seller,” such as seller 114, holds an asset token in the seller's asset wallet (e.g., platform digital wallet custody module 152), as depicted at block 432. Seller 114 requests (404) the asset token be listed for sale on an exchange, as illustrated at block 408. In response, the system 100 informs a broker/dealer (at block 416), such as the transaction ATS broker/dealer module 130, which generates a corresponding seller smart contract, and sends that seller smart contract to the seller for acceptance (shown at 406).

A second investor (depicted at block 414), referred to herein as the “buyer,” such as buyer 116, agrees (at 410) to acquire the asset token. In response, the platform informs the broker/dealer (at block 416), which generates a corresponding buyer smart contract, and sends (at 412) that buyer smart contract to the buyer (depicted at block 414) for acceptance.

The broker/dealer (at block 416) may perform a verification of funds available in the buyer's accounts, for example, to ensure that the buyer has a sufficient balance to settle the transaction. If not, system 100 may send the buyer a request to add additional currency (e.g., fiat currency, cryptocurrency, tokens, and/or other digital representations of value offered to complete the transaction) to their account(s) being used to fund the acquisition. System 100 may send a release request (at 418) to the buyer's fiat account (block 422), such as the currency custody module 156, to transfer the required amount of fiat currency from the buyer's fiat account (block 422) to the seller's fiat account (block 423), such as the currency custody module 150 via currency transfers (424).

The purchase price amount may be transferred from the buyer's fiat account to the seller's fiat account, minus a service fee (at 420) associated with the acquisition. For example, if there was a purchase of $1000 and a fee of $50, there would be a transfer of $950 from the buyer's fiat account to the seller's fiat account, and a transfer of $50 from the buyer's fiat account to the broker dealer (at block 416). A service fee may be transferred from the buyer's fiat account to the broker/dealer. On receipt of the required amount into the seller's fiat account (at block 423), the platform may inform the broker/dealer.

Various safety actions can ensure an asset token is transferred to an acquiring buyer (and not another user) during the transaction process, an asset token is appropriately delisted as for sale at system 100, and an asset token is free of tampering or interface during the transaction process. For example, at approximately the same time as (or concurrently with) the release request (at 418) sent system 100 to the buyer's fiat account (at block 422), a second release request (at 434) may be sent to the seller's asset token wallet (at block 432) to hold the asset token for the buyer. This combination of release requests may protect the buyer's currency by ensuring the buyer receives the asset token in exchange for the currency transferred to the seller of the asset token, by preventing the seller from interrupting the transfer of the asset token once the seller has accepted the terms to transfer the asset token.

On receipt of the agreed-upon payment, such as, amount of currency (e.g., fiat currency, cryptocurrency, etc.) into the seller's corresponding account, system 100 may transmit a confirmation of receipt to the seller's asset token wallet. In response to receiving the confirmation of receipt of the currency, the seller's asset token wallet (at block 432) may transfer (at 436) the asset token to the buyer's asset token wallet (at block 438), such as platform digital wallet custody module 162. Upon receipt of the asset token, the buyer's asset token wallet (at block 438) may transmit (at 440) confirmation of receipt of the asset token to the broker/dealer (at block 416), thereby completing the transaction. System 100 may update the capitalization table in the primary ledger, such as primary ledger 102 (shown in FIG. 1), to reflect the transaction, and then (possibly automatically) semi-redundantly synchronize the update to the secondary ledger, such as secondary ledger 104 (shown in FIG. 1), accordingly.

Although the acquire/transfer process has been described herein largely in terms of the exchange of fiat currency, either or both of the buyer and seller may use other digital representations of value (e.g., cryptocurrency or other digital tokens) instead of, or in addition to, fiat currency. System 100 may perform any conversions (at 454) between fiat currency, cryptocurrency, and/or other digital tokens as appropriate to facilitate and complete the transactions (444, 446) on system 100.

As described, other aspects include acquiring and transferring asset tokens with intermediate currency conversion through stablecoin. These other aspects include parties to a transaction desiring settlement in different types of currency, such as, for example, one party desiring crypto and another party desiring fiat. In these aspects, ATS broker dealer 416 can include a conversion engine and a coin characteristic module facilitating conversion between crypto and stablecoin and vice versa and between fiat and stablecoin and vice versa. The conversion engine and coin characteristic module may replace conversion 454 reducing potential currency volatility.

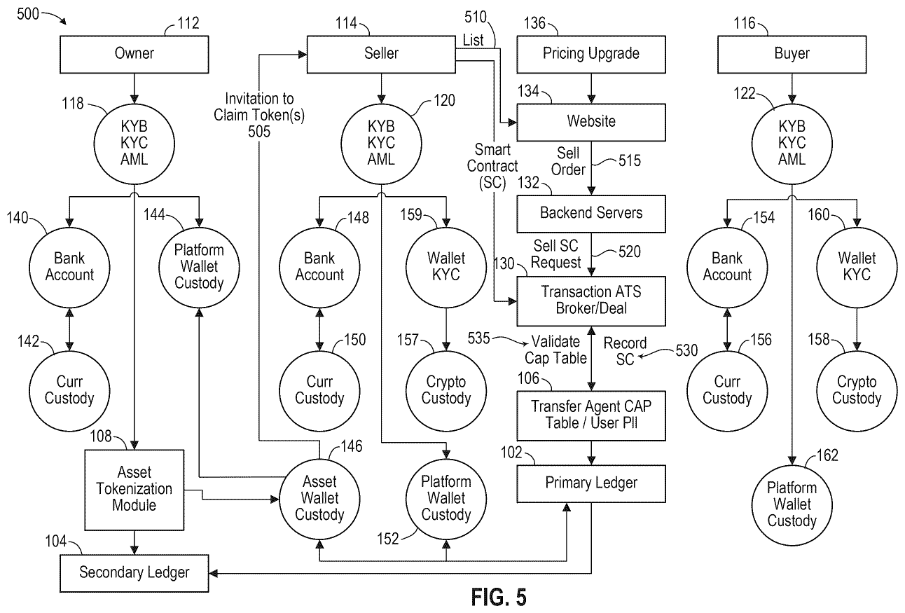

FIG. 5 illustrates an exemplary seller login and transaction flow 500, according to some embodiments of the disclosed technology. Process 500 can be implemented using the components of system 100. Seller 114 may register with and log into system 100 and be authenticated as an authorized user of system 100 according to KYB KYC AML 120 protocols and methodologies. Seller 114 may link bank account 148 and currency custody module 150 to system 100. Currency custody module 150 may serve as a custodian for seller 114's fiat currency on system 100. Platform digital wallet custody module 152 may serve as a custodian for seller 114's digital assets (e.g., tokens representing fractional ownership interests) on system 100.

Crypto custody module 157 may serve as a custodian for seller 114's crypto currency on system 100. Crypto custody module 157 may be configured to hold crypto currency, for example, Bitcoin (BTC), USDC, or other forms of crypto currency including other stablecoin. Crypto custody module 157 may authenticate with system 100 according to wallet KYC 159 protocols and methodologies.

Seller 114 may receive, from asset wallet custody module 146, an invitation 505 to claim digital assets (e.g., tokens) generated by the asset tokenization module 108 to represent investors'shares (fractionalized interest) in an asset tokenized by asset tokenization module 108. An example of such an asset may include real property, e.g., commercial real estate. When seller 114 claims the digital assets (tokens) generated by asset tokenization module 108, asset wallet custody module 146 may transmit the digital assets (tokens) to seller 114's platform digital wallet custody module 152. For example, seller 114 can claim digital assets (tokens) in order to subsequently trade the digital assets at system 100.

Concurrently, also when seller 114 claims the digital assets (tokens) generated by asset tokenization module 108, system 100 can transmit transfer information regarding the transfer (from 146 to 152) to the transfer agent 106. Transfer agent 106 can record the transfer information in primary ledger 102. The transfer information can be (e.g., automatically) semi-redundantly synchronized (e.g., with PII removed) to secondary ledger 104.

Seller 114 may then list 510 the asset and/or asset tokens on system 100 as being available for sale, purchase, exchange, investing in, transferring, or any other appropriate listing action. Seller 114 may list 510 the asset and/or asset tokens via the website 134. For example, website 134 can send user-interface data including listing 510 to a web browser at a computing device. The web browser can present a user-interface including listing 510 at the display device of the computing system. Listing 510 can include a list of multiple assets and/or asset tokens that are available on system 100. The web browser can present a user-interface including listing 510 of the multiple assets and/or asset tokens at the display device.

In one aspect, the user-interface including listing 510 is presented at a web browser of a computing device of buyer 116. In one aspect, listing 510 is presented to buyer 116 with prices indicated in a preferred currency (e.g., selected during account creation). Using an input device at the computing device, buyer 116 can select one or more of multiple assets and/or asset tokens for purchase from the web browser user-interface. Buyer 116's selection can be propagated back to website 134.

Responsive buyer 116's selection from the web-browser user interface, website 134 and/or backend servers 132 can generate a sell order 515. The sell order may be an order to request creation of a smart contract (SC) 525 to facilitate a sale, purchase, exchange, investment in, transferring of, or similar type of disposition of the selected asset(s) and/or asset token(s). In response to receiving the sell order 515, backend servers 132 may generate and transmit a sell SC request 520 to transaction ATS broker/dealer module 130 to request the creation of SC 525 between transaction ATS broker/dealer module 130 and seller 114.

Transaction ATS broker/dealer module 130 may establish SC 525 with seller 114 for the contemplated transaction involving the selected asset(s) and/or asset token(s) transferred to platform digital wallet custody module 152. Transaction ATS broker/dealer module 130 may record the smart contract (operation 530) and update and/or validate the capitalization (cap) table (operation 535) via transfer agent 106. Recording the smart contract and updating and/or validating the capitalization (cap) table can be based on the SC 525 and/or the asset tokens transferred to platform digital wallet custody module 152 by asset wallet custody module 146.

Transfer agent 106 may include and/or utilize user PII of seller 114 and/or owner 112 in the update and/or validation of the cap table. Transfer agent 106 may maintain an up-to-date copy of the cap table and related user PII. Transfer agent 106 may update the cap table and/or related user PII based on input provided via website 134 and routed to transfer agent 106 via backend servers 132 and/or transaction ATS broker/dealer module 130. Transfer agent 106 records the smart contract 525 as well as entries pertaining to the contemplated and performed transactions involving the asset and/or asset tokens in primary ledger 102 and (e.g., semi-redundantly synchronized) in secondary ledger 104.

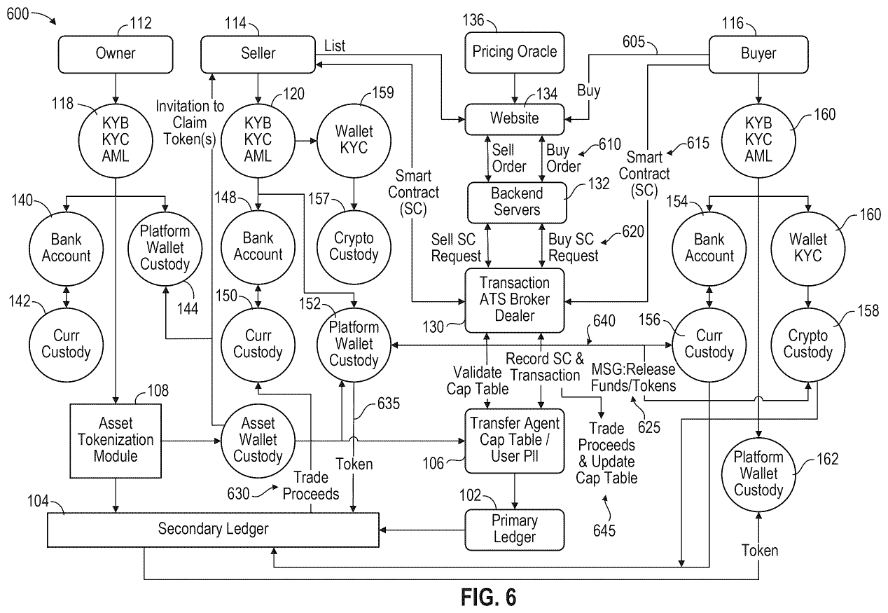

FIG. 6 illustrates an exemplary buyer login and transaction flow 600, according to some embodiments of the disclosed technology. Process 600 can be implemented using the components of system 100. Buyer 116 may register with and log into system 100 and be authenticated as an authorized user of the system 100 according to KYB KYC AML 122 protocols and methodologies. Buyer 116 may link bank account 154 and currency custody module 156 to system 100. Currency custody module 156 may serve as a custodian for buyer 116's fiat currency on system 100.

Crypto custody module 158 may serve as a custodian for buyer 116's crypto currency on system 100. Crypto custody module 158 may be configured to hold crypto currency, for example, Bitcoin (BTC), USDC, or other forms of crypto currency including other stablecoin. Crypto custody module 157 may authenticate with system 100 according to wallet KYC 160 protocols and methodologies.

Platform digital wallet custody module 162 may serve as a custodian for buyer 116's asset tokens acquired on system 100 by buyer 116.

As described, the user-interface including listing 510 is presented at a web browser of a computing device of buyer 116 and may be presented to with prices indicated in a preferred currency (and that may differ from a preferred currency of seller 114). Using an input device at the computing device, buyer 116 can select one or more of multiple assets and/or asset tokens for purchase from the web browser user-interface. Buyer 116's selection can be propagated back to website 134.

Thus, buyer 116 may view the listed asset and/or asset tokens on system 100 as being available for sale, purchase, exchange, investing in, transferring, or the like via website 134. Responsive to viewing the listing of the asset(s) and/or asset token(s) via website 134, buyer 116 may make an offer to buy 605 the listed asset(s) and/or asset token(s) via website 134. Responsive to buyer 116's offer to buy 605 the listed asset(s) and/or asset token(s), a buy order 610 may be generated by website 134 and/or backend servers 132 (which may host or control at least some aspects of the website 134).

Buy order 610 may be an order to request creation of a create smart contract (SC) 615 to facilitate a sale, purchase, exchange, investment in, transferring of, or similar type of disposition of the asset(s) and/or asset token(s). In response to receiving buy order 610, backend servers 132 may generate and transmit buy SC request 620 the transaction ATS broker/dealer module 130. Buy SC request 620 requests the creation of the SC 615 between transaction ATS broker/dealer module 130 and buyer 116. Transaction ATS broker/dealer module 130 may establish SC 615 with buyer 116 for the contemplated transaction involving the asset(s) and/or asset token(s) transferred to the platform digital wallet custody module 152.

Transaction ATS broker/dealer module 130 may perform on the SC 615 by: (1) transmitting electronic message(s) instructing crypto custody module 158 and/or currency custody module 156 to release buyer 116's purchase funds to be exchanged for seller 114's asset tokens and (2) transmitting electronic message(s) instructing platform digital wallet custody module 152 to release seller 114's asset tokens to be exchanged for buyer 116's funds (operation 625). Responsive to receiving a message from transaction ATS broker/dealer module 130, buyer 116 can release purchase funds (e.g., crypto, fiat, etc.) to Transaction ATS broker/dealer module 130. Concurrently, and also responsive to receiving a message from transaction ATS broker/dealer module 130, seller 114 can release one or more asset tokens to be purchased to transaction ATS broker/dealer.

Upon receiving (and verifying) the purchase funds and receiving the one or more tokens, transaction ATS broker/dealer module 130 can check the amount and the currency type used for purchase funds. When the currency type of purchase funds is crypto, ATS broker/dealer module 130 can (through reference to corresponding currency pair) interoperate with a conversion engine (and potentially a coin characteristic module) converting the amount of crypto to an equally valued amount of an appropriate stablecoin. ATS broker/dealer module 130 can convert from crypto to stablecoin in essentially real-time to minimize any adverse financial impact on buyer 116, seller 114, or system 100 due to volatility of the crypto. A similar technique may be used to convert received purchase funds in a less stable stablecoin into another appropriate more stable stablecoin. ATS broker/dealer module 130 can store the amount of appropriate stablecoin in an internal stablecoin wallet.

Subsequent to receiving purchase funds, and when appropriate, converting purchase funds to appropriate stablecoin, ATS broker/dealer module 130 can transmit electronic message(s) instructing seller 114 to transfer the purchased asset tokens to buyer 112. Responsive to receiving the message(s) from transaction ATS broker/dealer module 130, seller 114's platform digital wallet custody module 152 may transmit the purchased asset token(s) to buyer 116's platform digital wallet custody module 162.

Concurrently with transferring the purchased asset tokens, ATS broker/dealer module 130 facilitates delivery of trade proceeds 630 to seller 114. In one aspect, ATS broker/dealer module 130 transmits electronic message(s) instructing buyer 116 to transfer purchase funds/trade proceeds to seller 114. Responsive to receiving the message, currency custody module 156 and/or crypto custody module 158 may transmit trade proceeds 630 being exchanged for the asset token(s) to currency custody module 150 and/or crypto custody module 157 respectively. Thus, trade proceeds 630 can include crypto and/or fiat.

In one aspect, crypto custody module 158 may include or interface with a module configured to convert crypto into fiat acceptable by currency custody module 150.

Digital wallet custody module 158 can, alternatively or additionally, transmit trade proceeds 630 being exchanged for the asset token(s) that are held in crypto to digital wallet custody module 157. A blockchain may create and store a blockchain entry corresponding to the transfer of trade proceeds 630 from buyer 116's currency custody module 156 and/or digital wallet custody module 158 to seller 114's currency custody module 150 and/or digital wallet custody module 157, respectively.

In other aspects, seller 114's digital wallet custody module 157 can similarly include or interface with a module configured to convert crypto into fiat currency acceptable by buyer 116's currency custody module 156. Responsive to receiving the message from transaction ATS broker/dealer module 130, seller 114's platform digital wallet custody module 152 may transmit asset token(s) 635 to buyer 116's platform digital wallet custody module 162 per the terms of the smart contract 615. The blockchain may create and store a blockchain entry corresponding to the transfer of the asset token(s) 635.

In a further aspect, transaction ATS broker/dealer module 130, having previously received crypto from buyer 116 and converted the crypto to stablecoin, more directly handles transfer of trade proceeds. Transaction ATS broker/dealer module 130 can identify a currency preference for seller 114 from seller 114's account information. ATS broker/dealer module 130 can (through reference to corresponding currency pair) interoperate with the conversion engine converting the amount of stablecoin to an equally valued amount of seller 114's preferred currency, such as, fiat, another crypto, or another stablecoin. ATS broker/dealer module 130 can transfer the amount of the seller 114's preferred currency in essentially real-time to an appropriate custody module (e.g., 150 or 157) minimizing any adverse financial impact on buyer 116, seller 114, or system 100 due to volatility associated with seller 114's preferred currency.

Transaction ATS broker/dealer module 130 may record the smart contract and transaction (operation 640) and update and/or validate the capitalization (cap) table (operation 645) via the transfer agent 106, for example, based on the SC 615, including buyer 116, seller 114, amount of purchase funds, currency type of the purchase funds, amount of trade proceeds, currency type of trade proceeds, digital assets (e.g., tokens) transferred, etc. Transfer agent 106 may include and/or utilize user PII of buyer 116, seller 114, and/or owner 112 in the update and/or validation of the cap table. Transfer agent 106 may maintain an up-to-date copy of the cap table and related user PII. Transfer agent 106 may update the cap table and/or related user PII based on input provided via the website 134 and routed to transfer agent 106 via backend servers 132 and/or transaction ATS broker/dealer module 130. Transfer agent 106 may also record entries pertaining to the contemplated and performed transactions involving the asset(s) and/or asset tokens, including buyer 116, seller 114, amount of purchase funds, currency type of the purchase funds, amount of trade proceeds, currency type of trade proceeds, digital assets (e.g., tokens) transferred, etc., in the primary ledger 102 and (semi-redundantly synchronized) in secondary ledger 104.

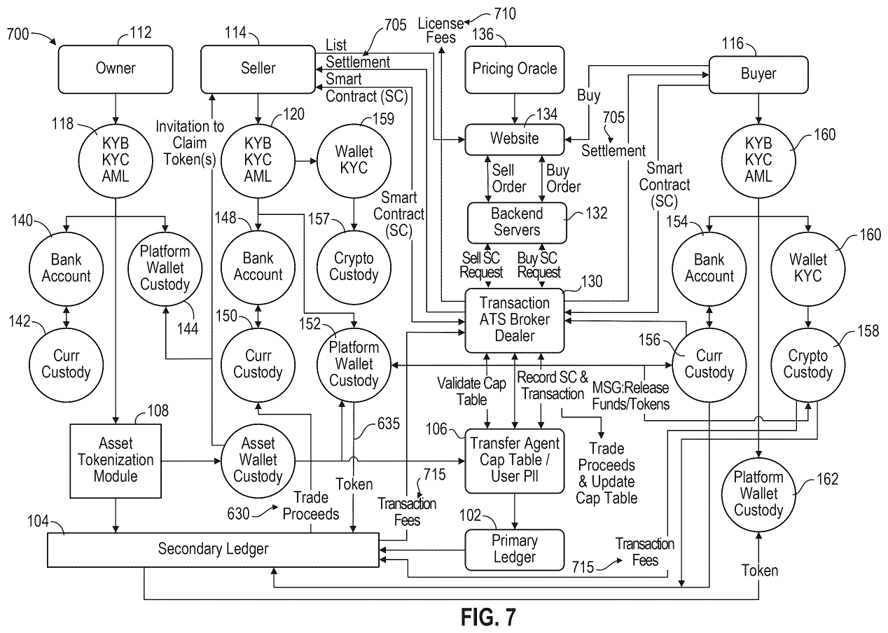

FIG. 7 illustrates an exemplary fee flow 700, according to some embodiments of the disclosed technology. Process 700 can be implemented using the components of system 100. As the trade proceeds are being transferred on system 100 as described with respect to FIGS. 5-6, transaction ATS broker/dealer module 130 transmits requests to buyer 116's currency custody module 156 and/or digital wallet custody module 158 and to seller 114's currency custody module 150 and/or digital wallet custody module 157 to collect transaction fees 715 for distribution. Transactions fees 715 can include, but are not limited to, licensing fees 710 distributed to transaction ATS broker/dealer module 130, partnership fees distributed to transfer agent 106, and other appropriate fees.

Transaction ATS broker/dealer module 130 may receive transaction fees 715 associated with the transaction completed (settled) on system 100 from the buyer 116's currency custody module 156 and/or digital wallet custody module 158 and seller 114's currency custody module 150 and/or digital wallet custody module 157. Transaction fees 715 may be payable and funded via fiat currency and/or cryptocurrency, for example, as described above. In some examples, transaction fees 715 may be payable and funded by other digital assets, for example, NFTs.

Moreover, transaction ATS broker/dealer module 130 transmits settlement statements 705 to seller 114 and/or buyer 116. The transfer of transaction fees 715 may be recorded on the primary ledger 102 and (semi-redundantly synchronized) on the secondary ledger 104. As depicted in FIG. 7, transaction fees 715 are payable by and transferred to the transaction ATS broker/dealer 130. However, this is merely an example, and in other examples, transaction fees 715 may be payable by and transferred to transaction ATS broker/dealer module 130 by any combination of owner 112, seller 114, buyer 116, and/or third parties outside system 100, and/or their associated currency custody modules, crypto custody modules, platform wallet custody modules, asset wallet custody modules, and/or the like.

Transaction ATS broker/dealer module 130 may distribute license fees 710 associated with the transaction completed (settled) on system 100 to those owed the license fees 710, such as, transaction ATS broker/dealer module 130. Examples of license fees may include royalties, service fees, intellectual property license fees, and software license fees for software, systems, and methods used by system 100 to complete (settle) the transactions. License fees 710 may be funded from the transaction fees 715 received by transaction ATS broker/dealer module 130.

The described systems, methods, and technologies provide numerous advantages over conventional systems. For example, system 100 may provide owners and sellers with the ability to exit a commercial real estate investment (as an asset) much earlier than the typical hold period for such asset types and with reduce possibility of adverse financial impacts due to currency volatility around the time of a transaction. In many commercial real estate investments, investors may hold the asset for five to seven (5 to 7) years for various reasons associated with processes and procedures for transferring ownership of the asset as a whole. At the end of the hold period (which may be mandated by statute, regulation, or other law, for example, SEC Rule 144), the owner of an investment property (e.g., commercial real estate) may either transfer the property or refinance the property. Refinancing the property may provide a liquidity event to the investor.

A technological system and method for fractionalizing and tokenizing such assets and utilizing stablecoin to mitigate potential currency volatility as described herein may provide owners of assets that would otherwise be subject to extended hold periods the ability to participate in liquidity opportunities and/or offer liquidity opportunities to their investors on a shorter timeline than with conventional legal processes, which may by and large be manually executed with extended delays. The technologies disclosed herein facilitate sellers in trading asset tokens and monetizing their investments in underlying assets, thereby unlocking an ability to re-invest capital and supporting the cycle of investment. For example, liquidity provided by the disclosed technology of system 100, even after just one year, may help create at least five to seven (5-7) times the liquidity in the entire ecosphere compared to traditional approaches. As an example, compared to traditional approaches in which a share of a real estate investment property is held for five (5) years, the technology disclosed herein may facilitate the asset tokens being traded five (5), ten (10), one hundred (100), or more times, for example, within the same five years.

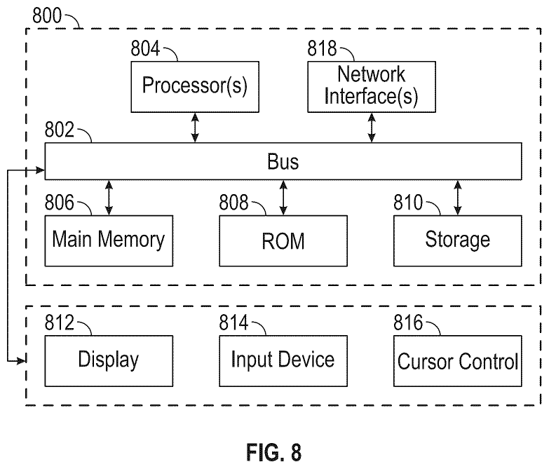

FIG. 8 depicts a block diagram of an example computer system 800 in which embodiments described herein may be implemented. System 100, computer architecture 1200, computer architecture 1400, computer architecture 1600, etc. can be implemented using components of and computing resources depicted in computer system 800 (which in turn can implement the various described techniques and methodologies). Computer system 800 may include bus 802 or other electronic communication mechanism for communicating information, and one or more hardware processors 804 coupled with bus 802 for processing information. Hardware processor(s) 804 may include, for example, one or more general purpose microprocessors and/or application specific integrated circuits (ASICs) configured to perform the processes and methods described herein and related processes and methods.

Computer system 800 also may include main (system) memory 806, for example, a random-access memory (RAM), cache, and/or other dynamic storage devices, coupled to bus 802 for storing information and instructions to be executed by processor(s) 804. Main memory 806 can also be used for storing temporary variables or other intermediate information during execution of instructions by processor(s) 804. Such instructions, when stored in storage media accessible to processor(s) 804, may render computer system 800 into a special-purpose machine that is customized to perform the operations specified in the instructions.

Computer system 800 may further include a read only memory (ROM) 808 and/or other static storage device coupled to bus 802 for storing static information and instructions for processor(s) 804. Storage device 810, for example, a magnetic disk, optical disk, and/or USB thumb drive (Flash drive), etc., may be provided and coupled to bus 802 for storing information and instructions.

Computer system 800 may be coupled via bus 802 to display 812, for example, a liquid crystal display (LCD), light emitting diode (LED) display, touch screen, and/or other electronic display for displaying information to a computer user. One or more input device(s) 814, including alphanumeric and/or other keys, may be coupled to bus 802 for communicating information and command selections to processor(s) 804. Another type of user input device may include cursor control 816, for example, a mouse, a trackball, a touchpad, and/or a set of cursor direction keys for communicating direction information and command selections to processor(s) 804 and for controlling cursor movement on display 812. In some examples, direction information and command selections (e.g., selecting assets and/or tokens from a listing) may be provided by cursor control may also or alternatively be implemented via receiving touches on a touch screen without the use of a separate cursor control device.

Computing system 800 may include a user interface module to implement a graphical user interface (GUI) that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the words “component,” “engine,” “system,” “database,” “data store,” and the like, as used herein, may refer to logic embodied in hardware or firmware, or to a collection of software instructions, possibly having entry and exit points, written in a programming language, such as, for example, Java, C, or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression, and/or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 800 may implement the techniques described herein using customized hard-wired logic, one or more ASICs or FPGAs, firmware and/or program logic which in combination with computer system 800 causes or programs computer system 800 to be a special-purpose machine. According to one embodiment, the techniques herein are performed by computer system 800 in response to processor(s) 804 executing one or more sequences of one or more instructions contained in main (system) memory 806. Such instructions may be read into main (system) memory 806 from another storage medium, such as storage device 810. Execution of the sequences of instructions contained in main (system) memory 806 may cause the processor(s) 804 to perform the methods and/or operations described herein. In alternative embodiments, hard-wired circuitry may be used in place of or in combination with software instructions.

The term “non-transitory media,” and similar terms, as used herein refers to any non-transitory media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main (system) memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media may also take the form of acoustic or light waves, such as those generated during radio-wave and infra-red data communications.

Computer system 800 may also include one or more communication network interface(s) 818 coupled to bus 802. Network interface(s) 818 may provide two-way data communication coupling to one or more network links that are connected to one or more local networks. For example, network interface(s) 818 may include an integrated services digital network (ISDN) card, cable modem, satellite modem, or a modem to provide a data communication connection to a corresponding type of telephone line. As another example, network interface(s) 818 may include a local area network (LAN) card to provide a data communication connection to a compatible LAN (and/or a wide area network (WAN) component to communicate with a WAN). Wireless links may also be implemented. In any such implementation, network interface(s) 818 send and receive electrical, electromagnetic, and/or optical signals that carry digital data streams representing various types of information.

A network link typically provides data communication through one or more networks to other data devices. For example, a network link may provide a connection through a local network to a host computer or to data equipment operated by an Internet Service Provider (ISP). The ISP in turn may provide data communication services through the worldwide packet data communication network now commonly referred to as the “Internet.” Local network and Internet both use electrical, electromagnetic, electronic, and/or optical signals that carry digital data streams. The signals through the various networks and the signals on network link and through network interface(s) 818, which may carry the digital data to and from computer system 800, are example forms of transmission media.

Computer system 800 may send and receive electronic messages and data, including program code, through the network(s), network link and network interface(s) 818. In the Internet example, a server might transmit a requested code for an application program through the Internet, the ISP, the local network, and network interface(s) 818.

The received code may be executed by the processor(s) 804 as it is received, and/or stored in the storage 810, or other non-volatile storage for later execution.

### Interaction Between Master Account Ledger and Escrow Account Ledger

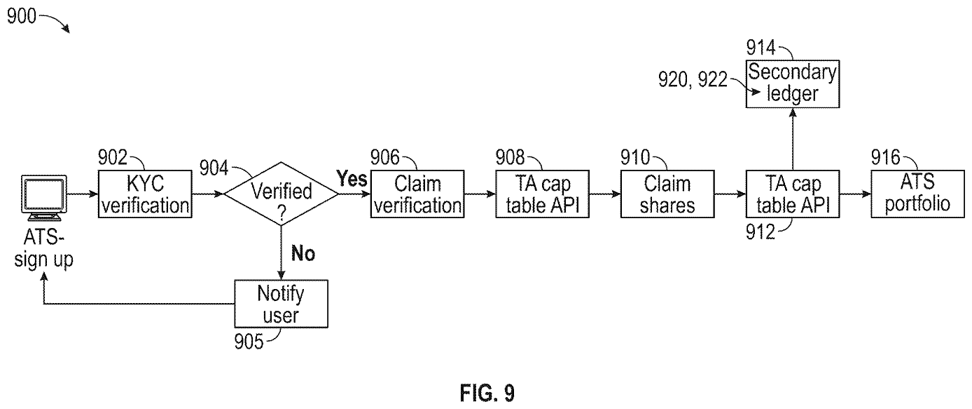

FIGS. 9-11 are block diagrams illustrating an exemplary process including an interaction with transaction flow between a master account ledger 920 and an escrow ledger 922, according to example embodiments of the disclosed technology. FIG. 9 illustrates an exemplary registration process 900 using the exemplary transaction platform of any of the systems of FIGS. 1 and 5-7 (e.g., system 100). For example, a user (e.g., the owner 112, the seller 114, or the buyer 116) can sign up on an Exchange (e.g., the transaction ATS broker/dealer 130). The user may be an individual or an entity, such as a limited liability company (LLC), a C-Corp, a partnership for a group of investors, for example. In example embodiments, at 902 individual people are verified via know your customer (KYC) and entities can be verified by know your business (KYB). If the user is not verified in the Exchange, the user is notified at 905 that verification failed and requested to remedy any errors and repeat the verification process at 902.

In example embodiments, the Exchange includes, but is not limited to, a traditional (e.g., primary) financial Exchange, a secondary market Exchange, an alternative trading system or ATS, and/or any other appropriate system or systems where securities, commodities, derivatives, and/or any other financial or real asset instruments are transacted. The user is prompted to go through the KYC approval process.

A user is successfully approved once the user's identity is verified at 904, and it is confirmed that the user is not on a watch list, and/or prohibited from accessing the platform for another KYC reason. Watchlists are created and maintained by governments, international organizations, law enforcement agencies, and other regulatory bodies (a well-known example is OFAC's Specially Designated Nationals and Blocked Persons). Once the user is verified at 904 and approved at 906, this information is sent from the Exchange to the transfer agent 106. The transfer agent 106 reviews the information for the user, and determines whether the user appears on any cap table that exists within the Exchange at 908. As described herein, in example embodiments, the cap table is a static document used by companies, funds, and other entities to document and track the ownership structure of that entity. If the user is a person who is registering on the Exchange with no prior investments in the assets available to trade on the Exchange, the user is new to the ecosystem and will not appear on any existing cap table. For example, the transfer agent 106 determines that Laura A. Cooper is a new user who does not appear as a current investor on the cap table of any of the assets currently listed on the Exchange. If the user is a person who has previously invested in an asset that is listed for trading on the Exchange, the user's name will appear in the cap table for that asset. Or for example, the transfer agent 106 determines that Robert E. Jones is a new user who is an investor in Multi-Family Apartment Building ABC, and he owns 1,000 shares of Property ABC (but he has not yet claimed those shares, as this is his first time interacting with the platform).

In the second example where the user exists on a cap table, the transfer agent 106 sends or transmits a message to the Exchange that indicates: 1) the name of the asset to be listed on the Exchange, and 2) a number of shares in that asset that are related to the new user. The Exchange receives this message from the transfer agent 106, and then creates a message in the user interface (via a webpage or a mobile application, for example) that prompts the user to claim the user's shares at 910. At this stage, the user is presented with the number of shares the user will have after conversion on the Exchange. If any part of the user's investment is not evenly divided (considered a “loss”), the user is presented with any loss that resulted from the fractionalization of the asset. In example embodiments, the user must agree to this loss by signature as part of claiming the user's shares. If the user does not agree to this loss, the user's shares simply remain unclaimed and will not trade on the Exchange. In other aspects, a “fractional share” (which cannot exceed more than the price of a single “full” share) is left on the cap table and cannot be claimed and sold.

In example embodiments, when the user agrees to any potential loss, and claims the user's shares, the Exchange notifies the transfer agent 106 that the claim process was completed. The transfer agent 106 updates the cap table for the subject asset at 912, noting that the user has claimed the shares (912) (and associating metadata on that user with the shares). In certain example embodiments, the user is required to proceed with the claim process for each asset individually (for which the user appears on a cap table). The user may also be required to proceed with the claim process not only for the user individually, but for any entity in which the user is an owner, for example, if the user is a member of an LLC and verified during the KYB process at 902 described above. For example, if the user is invested in three different assets on the Exchange (1,000 shares in a Multi-Family Apartment Building, 500 shares in a Franchise business, and 2,500 shares in a Self Storage center), the user is required to proceed through the claim process for each asset individually (and agree to any loss associated with each asset). This process allows a user to make individual choices for each investment, in contrast to requiring the user to agree to the concept of loss without an ability to differentiate between a larger loss on one asset and no loss on another asset, for example.

The “shares” referenced in example embodiments are digital asset representations of the original shares (percent of ownership) that the user has via the user's investment in an asset. The shares are digital asset representations for easier and faster trading on the Exchange (i.e., technology platform). The shares of the digital assets are created digitally when a given asset is fractionalized. Each digital share or digital asset has a unique identifier and an intrinsic dollar value at creation. This information is stored in the database (such as the primary ledger 102) via the transfer agent 106. At 914, this master database (e.g., the primary ledger 102) at, or in communication with, the transfer agent 106 level is also written to the secondary ledger 104 on the blockchain. After each transaction, the ATS portfolio related to the user or users is updated to represent the transaction and the current status of the ATS portfolio at 916.

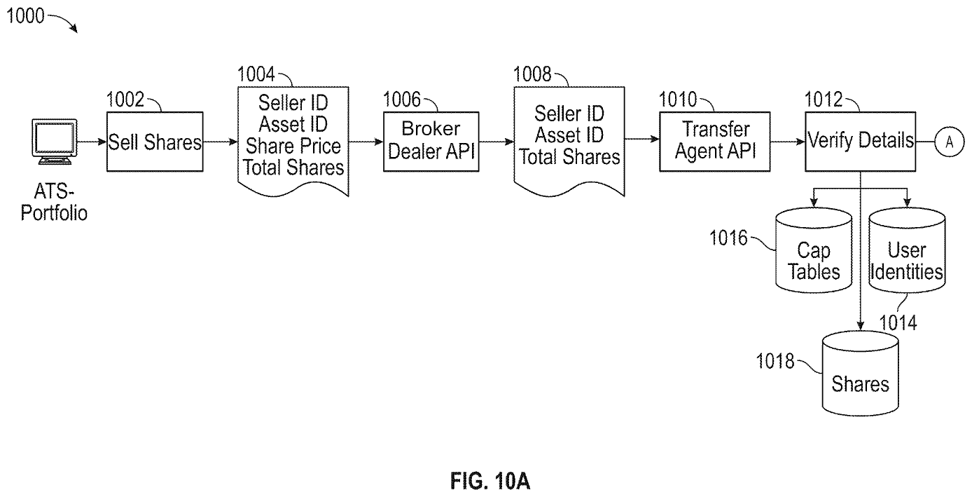

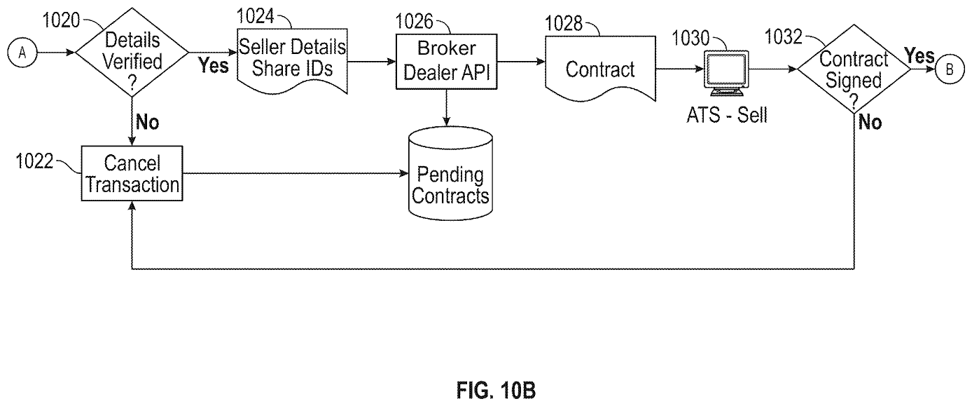

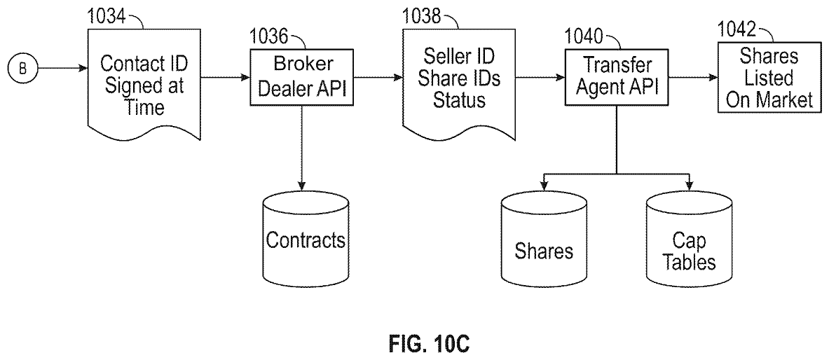

Referring further to FIGS. 10A, 10B, and 10C, in example embodiments after a user has claimed the user's shares, the user can elect to become a “seller” and sell at least a portion of the shares at any time. FIGS. 10A, 10B, and 10C collectively illustrate an exemplary sell flow 1000 using the exemplary transaction platform of any of the systems of FIGS. 1 and 5-7 (e.g., system 100). At step 1002, as the seller, the user selects which asset from which to sell any fraction of shares. For example, the user may decide to sell one share, a fraction of one share, or multiple shares at the same time (e.g., list one share only, list ten shares at once, or list 0.5 shares). The seller is presented with an interface allowing the seller to select a price per share and an amount of shares to offer for sale. The seller is able to adjust the price beyond the initial intrinsic value at which the shares are issued (during the initial fractionalization process). In certain example embodiments, the seller can also choose to fractionalize the user's shares further (for example, turning one share at $1,250 into 10 shares at $125). This additional fractionalization might be done if a seller wants to attract retail buyers to buy the user's shares and believes that a lower price point (e.g., $125/share) is more attractive and more accessible to a larger number of potential buyers, compared to a higher value (e.g., $1,250/share).

In example embodiments, the seller makes selections for the user's sell order on the platform (via a webpage or a mobile application, for example). Once the seller confirms that the sell order details are correct, the user clicks or selects the “sell” button, and transmits the sell order to the Exchange. The Exchange receives the information regarding the given sell order. Once the sell order is transmitted, the Exchange, e.g., the ATS, transmits the transaction details at step 1004 to the broker dealer. For example, the broker dealer may receive a user ID (seller ID), a total number of shares for sale and a share price, and an asset ID to which the shares belong (e.g., user 345 wants to sell 20 shares of Property ABC at $125 per share). At step 1006, the broker dealer receives that information and generates and transmits a request to the transfer agent 106 to verify the details, confirm the order is valid 1008. The transfer agent 106 accepts the order information (e.g., user 345 wants to sell 20 shares of Property ABC at $125 per share) and confirms that the trade can proceed beginning at step 1010. In order to verify the details of the proposed sale of shares at step 1012, the transfer agent 106 queries the database (e.g., the primary ledger 102) to confirm the KYC information for the user to ensure the user is currently KYC-compliant and able to complete the transaction in the Exchange (step 1014). The transfer agent 106 queries the cap table (step 1016) to verify that the seller owns the shares the seller is attempting to sell, and that those shares are in a “free” status (versus a “held” status as part of another trade)(step 1018). The transfer agent 106 also queries the cap table to verify that the share IDs match the parent asset IDs (to ensure there hasn't been an error in the data transmitted from the transaction ATS broker/dealer 130). The details regarding the transaction are verified at step 1020. If the transfer agent 106 determines that the information provided by the user generates an issue (e.g., the seller's KYC information is out of date, or the seller is attempting to sell more shares than the user owns), the transfer agent 106 returns an error message to the broker dealer of the transaction ATS broker/dealer 130 and cancels the transaction at step 1022. The broker dealer of the transaction ATS broker/dealer 130 will then send a message to the Exchange, and the Exchange will display an error message to the seller.

When the trade is acceptable and the transfer agent 106 verifies the information, at step 1024 the transfer agent 106 selects 20 shares (per the user's 345 order) from the cap table to list for sale, such as described below. The transfer agent 106 captures the share IDs for these 20 shares and transmits these share IDs to the broker dealer (along with a notification that the seller is in KYC “good standing”). At step 1026, the broker dealer of the transaction ATS broker/dealer 130 receives this information and creates a contract (e.g., a traditional contract, a “smart” contract, or a contract in any appropriate format) for the seller's review and execution at step 1028. The contract contains the terms of the transaction or trade (including the specific share IDs), and the seller's name (and, in certain embodiments, additional information from KYC that is required for the sell order contract). The broker dealer of the transaction ATS broker/dealer 130 transmits this contract to the Exchange, and the Exchange presents the contract to the seller at step 1030. The seller can then decide to accept or deny the terms of the contract. Assuming the seller accepts the terms of the contract and electronically signs the contract (step 1032), the Exchange notifies the broker dealer of the transaction ATS broker/dealer 130 that the contract has been signed (and transmits the contract to the broker dealer) at step 1034. At step 1036, the broker dealer of the transaction ATS broker/dealer 130 stores the signed contract in its database and notifies the transfer agent 106 that the contract has been successfully signed (step 1038). At step 1040, the transfer agent 106 indicates or marks the shares as a “Listed” or “Held for Sale” status (meaning, the shares are shown for sale at the specific price selected by the seller and cannot be relisted unless this original order is first canceled). The shares for sale are then listed at step 1042 on the Exchange. If the contract is not executed or the transaction details are not verified, the transaction is canceled and no changes are made at the transfer agent 106.

In example embodiments, in many instances during the specific share selection process for a given trade, the transfer agent 106 determines which shares are actually traded. This is relevant in instances where a seller has more than one share in a given asset and is not selling all of the user's shares. For example, user might have 45 shares in Property ABC. In this example trade, the user chooses to sell 20 shares of the total 45 shares. The question of which 20 shares of the total 45 shares should be listed for sale arises (and which 20 shares of the 45 shares are ultimately transferred to a buyer). In this example, the transfer agent 106 determines whether to select the shares for transfer using a First In Last Out (“FIFO”) method or a user-selected method, or other transfer agent 106 specified method.

The transfer agent 106 selects the FIFO method as the default choice in the absence of specific guidance from the seller. As a result, in the example transaction or trade discussed above, the shares for sale will be the “first 20 shares” of the total 45 shares that were previously created. FIFO is also relevant if a buyer has purchased shares on the Exchange over time, and then elects to sell some of these shares. For example, the user might have purchased 10 shares of Property LMN over an eight month time period (e.g., 3 shares in January, 2 shares in May, and 5 shares in July). In August, the user decides to sell 4 shares. Using the FIFO method, the transfer agent 106 selects the 3 shares purchased in January and 1 share of the 2 shares purchased in May, as the 4 shares to be listed for sale.

The user-selected method allows the user to instruct the transfer agent 106 to select particular shares of the total shares to list for sale. The user-selected method is relevant when a user specifically identifies the specific shares the user wishes to list (using the identification numbers found in the user's portfolio). A user might make certain selections for tax reasons (e.g., the user may realize a bigger or smaller loss or a bigger or smaller gain based on the original value of the shares at purchase versus the current market environment, or based on depreciation or other characteristics).

In example embodiments, the KYC information on a given user, and the personal identifiable information (“PII”) the user provided as part of the registration and KYC process, all resides within the transfer agent 106 in the master database. Neither the Exchange nor the broker dealer of the transaction ATS broker/dealer 130 has access to this information. This data structure is created to enhance or heighten the security of the entire Exchange ecosystem. The transfer agent 106 is completely isolated to an internal network that is not accessible to the outside world (only accessible via VPN, with credentials, and optionally via one or multiple other proprietary security protocols). The transfer agent databases are also hosted in a different system that cannot be found or accessed by an outside third party. The Exchange has publicly available APIs that, in theory, sophisticated hackers could try to manipulate. In the event there is a breach, bad actors will not be able to access any user PII.

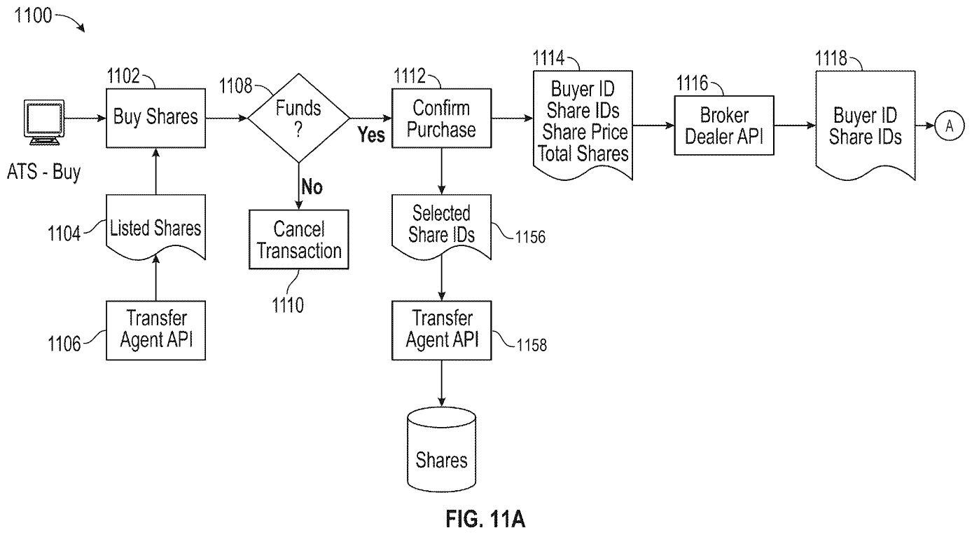

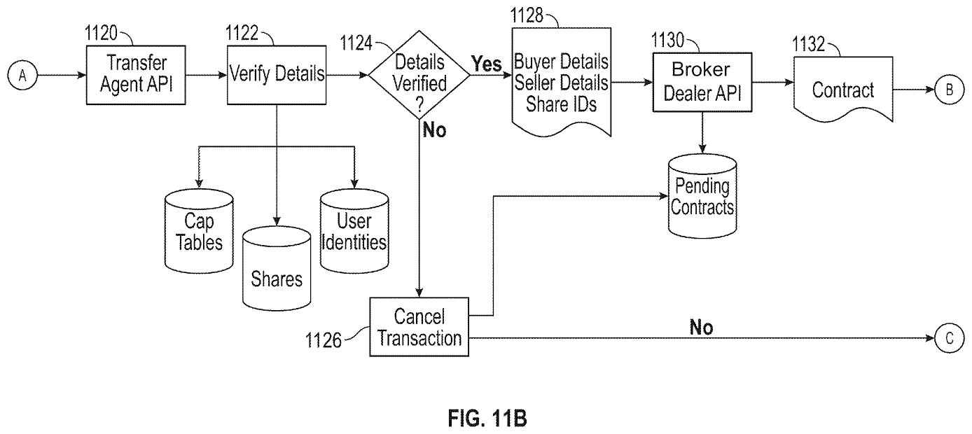

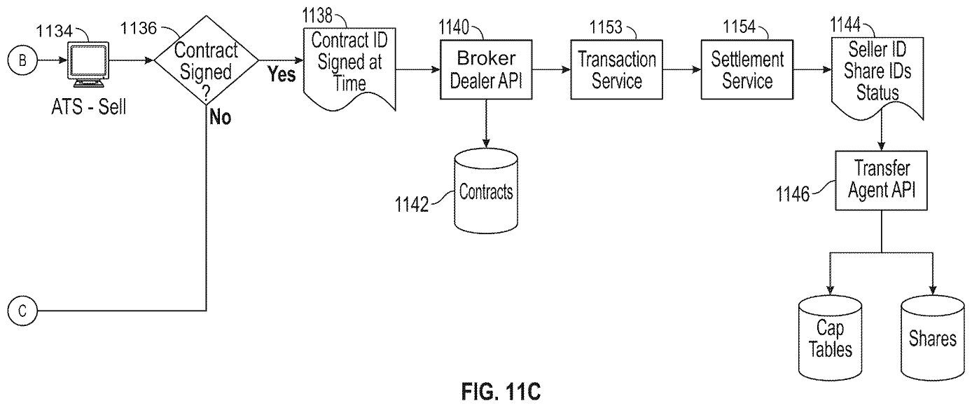

FIGS. 11A, 11B, and 11C collectively illustrate an exemplary buy flow 1100 using the exemplary transaction platform of any of the systems of FIGS. 1 and 5-7 (e.g., system 100). Referring now to FIGS. 11A, 11B, and 11C, in example embodiments, the user that: (a) registers for the Exchange, (b) successfully completes KYC, (c) successfully links a financial account (e.g., a bank account, a crypto wallet, or any other suitable financial account storing an amount of currency or other medium of value) to the Exchange, and (d) transfers funds from the external financial account to the user's account on the Exchange, is then able to buy shares. At step 1102, the user is able to enter the marketplace, to view the available shares listed for various assets (step 1104), and then elect to buy shares of a given asset. In example embodiments, from the marketplace, a buyer can find available shares from purchase and is redirected to a purchase screen where all the available shares for an asset are listed group by price. Via the transfer agent 106, the page is automatically updated at step 1106 as the other buyers complete transactions for the same asset so only currently available shares of assets are shown to the buyer. Before the buyer can proceed with purchasing desired shares, the ATS of the transaction ATS broker/dealer 130 verifies that the buyer has the needed funds available via the master account ledger 920 and escrow ledgers 922 on the secondary ledger 104 at step 1108. If the ATS of the transaction ATS broker/dealer 130 determines that the buyer does not have the needed funds available to purchase the desired shares, the transaction is canceled (1110). When the ATS of the transaction ATS broker/dealer 130 verifies that the buyer has the needed funds available to purchase the selected shares, the purchase is then confirmed by the buyer at step 1112 (e.g., transfer agent API 1158 identifying shares from selected share IDs 1156) by selecting to “buy” the shares on the Exchange.

To carry on the prior example, a user (“buyer”) might decide to buy 5 shares of Property ABC at $125/share (5 shares of the total 20 shares that the user identifies as listed for sale). The buyer, does not know the seller; the buyer only sees 20 shares for Property ABC listed for sale at $125/share. There may also be more than 20 shares for sale for Property ABC (if other users that own other shares for Property ABC have also listed the shares for sale). In this example, the seller is assumed to demand the cheapest listing price, so the buyer naturally selects to purchase or buy 5 shares of this seller's total 20 shares. Similar to the sell order process, when the buyer selects or clicks “buy” on the Exchange, the Exchange gathers the information on the order. This order information is also transferred to the broker dealer of the transaction ATS broker/dealer 130.

In example embodiments, at step 1114 a user ID, a number of shares for purchase, a share price, and an asset ID to which the shares belong (e.g., buyer wants to buy 5 shares of Property ABC at $125 per share) are transmitted to the broker dealer. At step 1116, the broker dealer of the transaction ATS broker/dealer 130 receives this information and generates and transmits a request to the transfer agent 106 with the buyer ID and share IDs (step 1118), for example, to confirm the order can be completed. Transfer agent API 1120 accepts the order information and confirms that the trade can proceed. In example embodiments, at step 1122 the transfer agent 106 queries the database to confirm the KYC information for the buyer to ensure the buyer is still KYC-compliant and able to complete the transaction in the Exchange. In example embodiments, the transfer agent 106 confirms share IDs, a parent asset ID, and an available quantity of shares in the “Listed” or “Held for Close” status and confirms that the details are verified at step 1124. As described with respect to the sell process, if any check performed by the transfer agent 106 detects an issue, the transfer agent 106 generates and returns an error message to the broker dealer of the transaction ATS broker/dealer 130. The broker dealer of the transaction ATS broker/dealer 130 will then send a message to the Exchange, and the Exchange will display an error message to the buyer at step 1126.

When the transfer agent 106 confirms the details and information, at step 1128 the transfer agent 106 selects 5 shares from the available 20 shares on the cap table, captures the share IDs for these 5 shares, and transmits these share IDs to the broker dealer of the transaction ATS broker/dealer 130 (along with a notification that the buyer is in KYC “good standing”). Broker dealer API 1130 receives this information and creates a contract (step 1132) for the buyer's review and execution. The contract contains the terms of the trade (including the specific share IDs), and the buyer's name (and additional information from KYC that is required for the buy order contract). The broker dealer transmits this contract to the Exchange, and the Exchange presents the contract to the buyer at step 1134. The buyer then determines whether to accept or deny the terms of the contract at step 1136. When the buyer accepts the terms and electronically signs the contract 1138, the Exchange notifies the broker dealer API 1140 that the contract has been executed (and transmits the contract to the broker dealer).

The broker dealer accepts the executed contract (step 1140) and stores the executed contract in its database (step 1142) and notifies the transfer agent 106 that the contract has been successfully executed offering transaction services 1153 and settlement services 1154 to complete the transaction. Different transaction services 1153 and settlement services 1154 can be offered based at least in part on an asset type. For example, different transaction services 1153 and settlement services 1154 can be offered when a transaction includes a real estate asset, relative to a private credit asset, relative to an investment fund asset, etc. Different transaction services 1153 and settlement services 1154 can also be offered based at least in part on different currency types (e.g., any of: a fiat type, a crypto type, a stablecoin type, etc.) used to settle a transaction. For example, different transaction services 1153 and settlement services 1154 can be offered when a transaction is settled in first crypto currency type, relative to a second crypto currency type, relative to a first stable coin type, relative to a second stable coin type, relative to a first fiat currency type, relative to a second fiat currency type, etc.

At step 1144, after receiving the seller ID, the share IDs, and the status of the transaction, the transfer agent 106 updates the cap table to reflect the transfer of shares from the seller to the buyer, and once this transfer is complete, the funds move from the buyer's account to the seller's account via the Exchange, at step 1146.

Regarding the “Held” status, in example embodiments, when the buyer selects or clicks “buy” on the platform interface (via a website or a mobile application, for example), the Exchange notifies the transfer agent 106 that a potential “closing action” of an order is coming through. This means that a user is taking an action on shares that will close, or “settle”, a trade (because the user is taking the second side of an open trade). This is in contrast to the initial sell order (that was an “opening action” because there was no buyer yet on the other side). This is relevant because the transfer agent 106 will apply a different “Held” status to the shares in question because the shares in question are currently in a “Listed” or “Held for Sale” state (opening action—listed for sale). The transfer agent 106 now marks the shares as “Held for Close” status, meaning that although the trade has not been confirmed, the shares will be momentarily removed from circulation to give the system a chance to perform the necessary checks, and allow the buyer a chance to close the trade. This process prevents a different user from seeing the shares and attempting to buy the shares during this period of trade completion.

In example embodiments, the broker dealer of the transaction ATS broker/dealer 130 holds the legal agreements that are relevant to specific transactions, including, without limitation, the seller agreement to sell terms and associated contract, the buyer agreement to buy terms and associated contract, and/or the user Non-Disclosure Agreements (“NDAs”) to inspect specific documents related to a specific asset to which the user is associated (e.g., buyer or seller). The Exchange holds the agreements that pertain to a given user interacting within the Exchange ecosystem, including, without limitation, terms of service, a privacy policy, and/or tax status attestations. In example embodiments, no agreements appear in the transfer agent ecosystem or reside in the transfer agent database.

When users enter the Exchange ecosystem, and complete the registration process (and successfully complete KYC), each user is prompted to link the user's external financial account to the user's account at the Exchange. This is not required for a user to claim the user's shares, list the user's shares for sale, or generally interact with the Marketplace (e.g., review assets for sale). However, if a user wants to buy shares, or if a user sells shares and wishes to withdraw the trade proceeds, the user is required to complete this external linking of a financial account. There are multiple ways to manage the flow of funds, secure custody of client funds, and implement anti-fraud provisions within an Exchange ecosystem. Some examples include, but are not limited to, an omnibus account with a third party institution, multiple accounts spread over multiple institutions, an in-house account (with no involvement of a financial institution). In this Exchange setup, for example, all funds are kept in an omnibus account at a third party financial institution. The rationale for keeping the funds at a third party financial institution includes reducing or eliminating a risk of unauthorized access by bad actors, e.g., hacking by bad actors, into the Exchange and stealing funds. However, it is necessary to keep track of all funds kept within this omnibus account and have an up-to-date reconciliation of these funds at any given moment. To ensure this requirement is met, there are two primary ledgers that are responsible for monitoring the status of all funds within the Exchange ecosystem at any given time: a master account ledger 920 and an escrow ledger 922, both of which can be written to the secondary ledger 104 of the Exchange ecosystem.

In example embodiments, the master account ledger 920 of the secondary ledger 104 tracks each user having funds associated with the user in some capacity within the Exchange. For example, funds transferred into the user's account from an external bank account, funds paid to a seller after purchasing shares on the Exchange, and/or funds earned by selling shares on the Exchange. The escrow ledger 922 of the secondary ledger 104 tracks funds, such as, fiat currency, stablecoin, crypto, etc., that are in flight. In flight funds include: (1) funds in the process of being transferred into the Exchange from an external account (e.g., a bank account in a situation where the ACH has been initiated but will not clear for some amount of time [e.g., 3-4 days], a stablecoin wallet or a crypto wallet in a situation where a transfer has been initiated but will not clear due to a delay, such as, blockchain congestion, etc.), (2) funds in the process of being transferred out of the Exchange to an external account (e.g., a bank account with the same or similar time delay as above, a stablecoin wallet or a crypto wallet with a delay, such as, blockchain congestion, etc.), (3) funds that are in the process of being transferred from a buyer to a seller as part of a trade settlement process, and/or (4) funds that are in the process of being transferred to the broker dealer's fee account (on a per-transaction basis) as part of the trade settlement process. Associated fees are conventionally paid by the seller, for example, a 5% fee of $50 might be removed from the seller's $1,000 proceeds as the transaction fee, and the $50 payment is transmitted to the broker dealer.

In example embodiments, the Exchange is responsible for maintaining both the master account ledger 920 of the secondary ledger 104 and the escrow ledger 922 of the secondary ledger 104. Funds are not transferred between the buyer and the seller until the transfer agent 106 confirms that the shares have successfully been transferred. When a trade is initiated by the buyer, the escrow ledger 922 of the secondary ledger 104 is updated by the Exchange to reflect funds that are now “earmarked” for a transaction. The Exchange is able to understand the combination of the ledger information on the master account ledger 920 of the secondary ledger 104 and the escrow ledger 922 of the secondary ledger 104 to fully understand a given user's financial position within the Exchange, allowing the transfer agent 106 to approve or deny a buy order.

The structure of using a master account ledger 920 and an escrow ledger 922, which may both be on the of the secondary ledger 104, prevents bad actors'ability to “game the system” by taking advantage of in flight funds.

For example, in a first example of actions by a bad actor, a user has $10,000 in an account on Day One and requests a withdrawal. The user knows that the funds will be withdrawn on Day Four, and the user places a trade for shares on Day Four (shortly before the actual withdrawal of funds). The user would then have gained shares and yet also withdrawn funds. In a situation where the financial ecosystem only has a master account ledger 920, the user's account will show $10,000 on Day One, Day Two, Day Three, and Day Four (and then $0 on Day Four). The system may not know that the $10,000 will go to $0 on Day Four and, in theory, may allow a buy order to proceed, resulting in a loss of $10,000 to the Exchange.

In a situation where the financial ecosystem has the master account ledger 920 as well as an escrow ledger 922, this risk is removed. The master account ledger 920 will show $10,000 on Day One, Day Two, Day Three, and Day Four (and then $0 on Day Four), but the escrow ledger 922 will show $0 at the start of Day One, and then a-$10,000 action on Day One, Day Two, Day Three, and Day Four, and then a return to $0 on Day Four, resulting in a net account value of $0 after the initiation of the withdrawal. In the trade flow in the Exchange, the transfer agent 106 confirms the users ID in both the master account ledger 920 of the secondary ledger 104 and the escrow ledger 922 of the secondary ledger 104. The system will, therefore, know that although the user's account balance is $10,000, the user has taken an action to remove $10,000 from the account. This will create an alert of insufficient funds if and when the user attempts to buy shares at any point after the action to withdraw funds has been initiated.

In a second example of actions by a bad actor, a user has $10,000 in an account on Day One and executes a trade to buy shares for $7,000. Prior to a trade settlement, the user attempts to buy additional shares worth $8,000 (for a total of $15,000, which is $5,000 over the account balance). In a situation where the financial ecosystem only has a master account ledger 920, the user's account would show $10,000 at Trade One (buy of $7,000). The system would continue to reflect $10,000 until that trade settles. The buyer could then use that same $10,000 to affect a trade valued at $8,000, which could in theory be approved if only confirming versus the master account ledger 920 (and a balance of $10,000 shows), resulting in the user having $15,000 worth of shares with a loss of $5,000 to the Exchange.

In the situation where the financial ecosystem has the master account ledger 920 as well as an escrow ledger 922, this risk is removed. The master account ledger 920 will still show $10,000 prior to the Trade One settlement and the escrow ledger 922 will show $0 prior to the Trade One initiation, and then a −$7,000 action after the initiation of Trade One, resulting in a net account value of $3,000. In the trade flow in the Exchange, the transfer agent 106 confirms the user's ID in both the master account ledger 920 of the secondary ledger 104 and the escrow ledger 922 of the secondary ledger 104. The system, therefore, knows that the user's account balance is $3,000; thus, generating an alert of insufficient funds if and when the user attempts to buy shares in Trade Two at a value of $8,000.

Similar scenarios using other fiat currencies, stablecoin, or crypto are also contemplated.

### Determining Stablecoin Stability

As described, “stablecoin” is a type of crypto currency where the value of units (e.g., coins) is pegged to a reference asset, such as, for example, fiat currency, exchange-traded commodities (e.g., precious metals or industrial metals), other crypto currency, crypto currency portfolios, another stablecoin, etc. Thus, based at least in part on a reference asset, different stablecoin types can have different volatilities. Other factors, such as public coin data, private coin data, economic data, currency data, etc. can also alter the volatility of a stablecoin type.

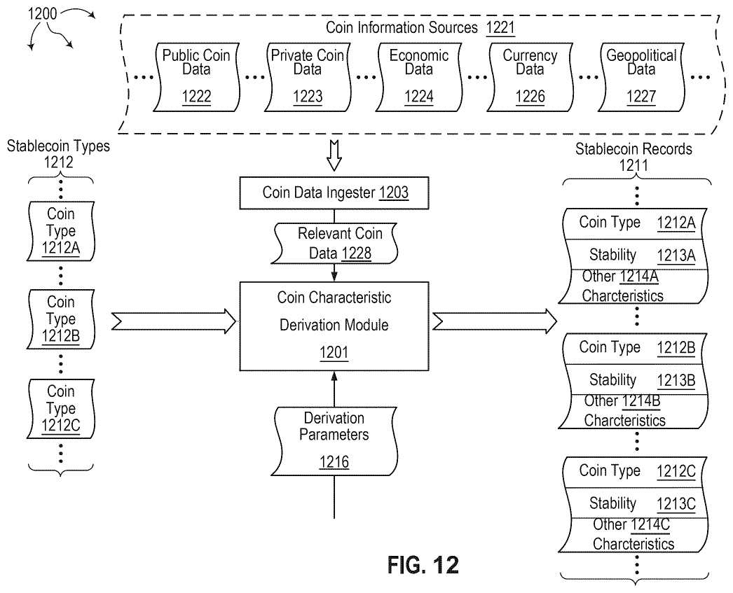

FIG. 12 illustrates an example computer architecture 1200 that facilitates determining stablecoin stability. The components of FIG. 12 can include, be integrated and/or implemented within and/or can otherwise interoperate with any of the components in FIGS. 1-7, of computer system 800, of registration process 900, of sell flow 1000, or of buy flow 1100, including one or more of: broker dealer API 1006/1026/1036, transfer agent API 1010/1040, verify details 1012, transfer agent API 1106/1158/1120/1146, confirm purchase 1112, broker dealer API 1116/1130/1140, transaction service 1153, settlement service 1154, etc.

As depicted computer architecture 1200 includes coin characteristic derivation module 1201 and coin data ingestor 1203. Generally, coin characteristic derivation module 1201 is configured to formulate stablecoin records for a plurality of stablecoin types. Each stablecoin record can indicate stability characteristics and other characteristics of a corresponding stablecoin type. In aspects, coin characteristic derivation module 1201 formulates stablecoin records based on relevant coin data and in accordance with derivation parameters.

Coin data ingestor 1203 is configured to ingest coin information from a variety of coin information sources, filter the ingested coin information into relevant coin data, and send relevant coin data to coin characteristic derivation module 1201. Coin characteristic derivation module 1001 can receive relevant coin data from coin data ingestor 1203.

In general, derivation parameters 1216 define when and how stablecoin characteristics are to be derived. In one aspect, derivation parameters define how often coin data is to be ingested and stablecoin characteristics to be derived. For example, derivation parameters can define ingesting coin data and/or deriving stablecoin characteristics on a constant, ongoing basis, on demand when requested, in response to specified events, at designated times or intervals, at specified frequencies (e.g., every minute, every second, every 10 ms, etc.). Derivation parameters 1216 may define different coin data ingestion and stablecoin characteristic derivation for different stablecoins.

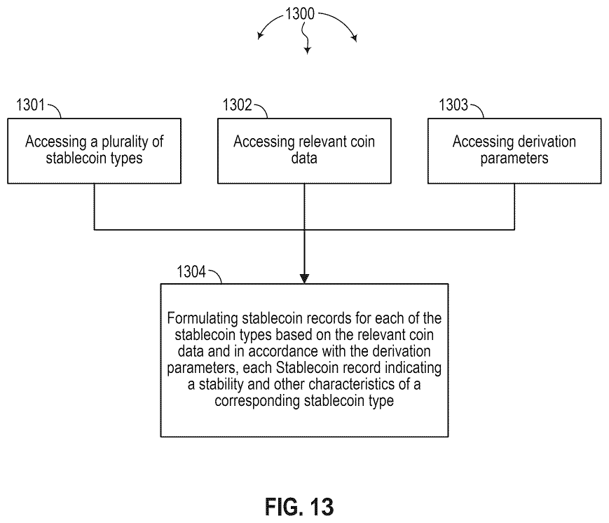

FIG. 13 illustrates a flow chart of an example method 1300 for determining stablecoin stability. Method 1300 will be described with respect to the components and data in computer architecture 1200. As such, method 1300 is suitable for use with any of the components in FIGS. 1-7, of computer system 800, of registration process 900, of buy flow 1000, or of sell flow 1100.

Method 1300 includes accessing a plurality of stablecoin types (1301). For example, coin characteristic derivation module 1201 can access stablecoin types 1212, including coin type 1212A, coin type 1212B, coin type 1212C, etc. Method 1300 includes accessing relevant coin data (1302). For example, coin characteristic derivation module 1201 can access relevant coin data 1228 from coin data ingestor 1203. Coin data ingestor 1203 can ingest coin data from coin information sources 1221, including public coin data 1222, private coin data 1223, economic data 1227, currency data 1226, geo political data 1227, etc. Coin data ingestor 1203 can filter the ingested coin data into relevant coin data 1228 and send relevant coin data 1228 to coin characteristic derivation module 1201.

Method 1300 includes accessing derivation parameters (1303). For example, coin characteristic derivation module 1201 can access derivation parameters 1216. Derivation parameters 1216 can define, for example, on a per coin type basis, when and how stablecoin records are to be formulated. In one aspect, derivation parameters 1216 define how stable coin stabilities are to be derived (e.g., formulas). The coin stability formulas can be applied to relevant coin data for a coin type to derive a corresponding coin stability for the coin type, for example, over defined historical periods, predicted for future time periods, etc. As described, derivation parameters 1216 can define that stablecoin records are to be formulated at specified times, on regular intervals, at particular frequencies, in response to specified events, etc. A specified event may include when a coin type is being considered for use at system 100, when resource usage at system 100 (e.g., computing, system memory, storage, network, etc.) is below specified thresholds, etc.

Derivation parameters 1216 can also define how other characteristics for a coin type are to be derived. Other characteristics can include coin usage restrictions, reference asset category, algorithmic/non-algorithmic, transparency, etc. Some coin types may be restricted in some jurisdictions, restricted for some types of transactions, restricted for transactions for specified assets, etc. Also, a stablecoin with increased stability may be associated with reduced transparency into the stablecoin's valuation. The reduced transparency can decrease the likelihood of system 100 using the stablecoin.

Method 1300 includes formulating stablecoin records for each of the stablecoin types based on the relevant coin data and in accordance with the derivation parameters, each stable coin record indicating a stability and other characteristics of a corresponding stablecoin type (1304). For example, coin characteristic derivation module can formulate stablecoin records 1211, including stablecoin record 1211A, stablecoin record 1211B, stablecoin record 1211C, etc. As depicted, stablecoin record 1211A is for coin type 1212A and indicates stability 1213A and other characteristics 1214A. Similarly, stablecoin record 1211B is for coin type 1212B and indicates stability 1213B and other characteristics 1214B. Similarly, stablecoin record 1211C is for coin type 1212C and indicates stability 1213C and other characteristics 1214C.

A currency conversion engine can consider stablecoin records 1211 when selecting a stablecoin, from among stablecoin types 1212, for use in intermediate currency conversions (and to mitigate potential adverse financial impacts of currency, and more specifically crypto, volatility) when performing/settling a transaction.

### Currency Conversions Associated With Digital Asset Transactions

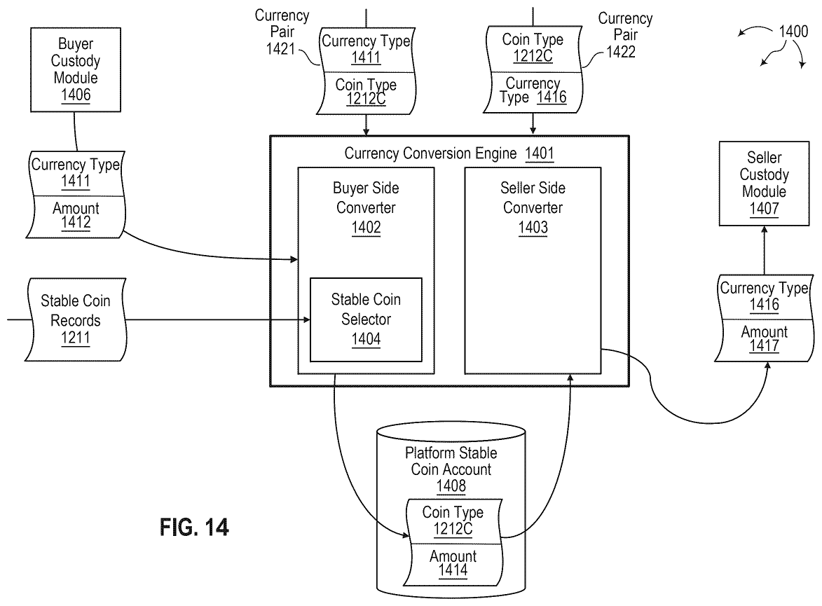

As described, a currency conversion engine can be utilized to mitigate potential adverse financial impacts to parties participating in a transaction from currency volatility. FIG. 14 illustrates an example computer architecture 1400 that facilitates handling currency conversions associated with digital asset transactions. The components of FIG. 14 can include, be implemented within and/or can interoperate with any of the components in FIGS. 1-7, of computer system 800, of registration process 900, of sell flow 1000, or of buy flow 1100, including one or more of: broker dealer API 1006/1026/1036, transfer agent API 1010/1040, verify details 1012, transfer agent API 1106/1158/1120/1146, confirm purchase 1112, broker dealer API 1116/1130/1140, transaction service 1153, settlement service 1154, etc.

As depicted, computer architecture 1400 includes currency conversion engine 1401, buyer custody module 1406, seller custody module 1407, and platform stablecoin account 1408. Currency conversion module further includes buyer side converter 1402 and seller side converter 1403. Buyer side converter 1402 further includes stablecoin selector 1404.

In general, currency conversion engine 1401 is configured to receive an amount of a currency type (e.g., a buyer preferred currency type) being used to purchase a digital asset (e.g., to purchase a token created by asset tokenization module 108). Currency conversion engine 1401 converts the amount of the currency type into an equally valued amount of stablecoin. Currency conversion module 1402 deposits the amount of stablecoin in platform stablecoin account 1408 (e.g., an account maintained internally by transaction ATS broker/dealer 130). Subsequently, currency conversion engine 1401 withdraws the amount of stable coin from the platform stablecoin account 1408. Currency conversion engine 1401 converts the amount of stable coin into an equally valued amount of another currency type (e.g., a seller preferred currency type). Currency conversion engine 1401 sends the amount of the other currency type as trade proceeds of the digital asset purchase.

In one aspect, some amount of stablecoin is retained at platform stablecoin account 1408 to pay any fees associated with a transaction. The stablecoin can be converted into fiat or other appropriate currency and sent to relevant parties to pay fees. As such, disbursed trade proceeds can be reduced by fees associated with the transaction. More specifically, buyer side converter can receive the amount of the currency type being used to purchase a digital asset. Stablecoin selector 1404 can, on its own and/or through reference to stablecoin records, select an appropriate stablecoin. Buyer side converter 1402 can convert the amount of the currency type to an equally valued amount of the appropriate stablecoin, potentially through reference to a corresponding currency pair. Buyer side converter 1402 can then deposit the amount of the appropriate stablecoin into platform stablecoin account 1408.

Subsequently, (e.g., concurrently with transferring a purchased asset to a buyer) seller side converter 1403 can withdraw the amount of the appropriate stablecoin. Seller side converter 1403 can access a preferred currency associated with a seller (e.g., from seller account information). Seller side converter 1403 can convert the amount of the appropriate stablecoin type (potentially minus any associated fees) to an equally valued amount of the seller's preferred currency, potentially through reference to a corresponding currency pair. Seller side converter 1403 can disburse the amount of the seller's preferred currency as trade proceeds.

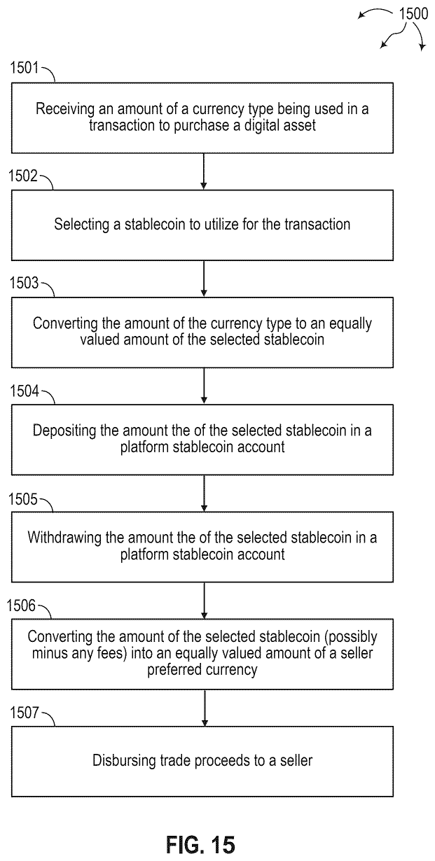

FIG. 15 illustrates a flow chart of an example method 1500 for handling currency conversions associated with digital asset transactions. Method 1500 will be described with respect to the components and data in computer architecture 1400. As such, method 1500 is suitable for use with any of the components in FIGS. 1-7, of computer system 800, of registration process 900, of buy flow 1000, or of sell flow 1100. Method 1500 includes receiving an amount of a currency type being used in a transaction to purchase a digital asset (1501). For example, currency conversion engine 1401 can receive amount 1412 of currency type 1411 from buyer custody module 1406. A buyer associated with buyer custody module 1406 can be using amount 1412 of currency type 1411 to purchase a token at an ATS (e.g., at system 100). The token can represent a fractional interest in another asset. Currency type 1411 may be a crypto type, a stablecoin type, or a fiat type. Method 1500 includes selecting a stablecoin to utilize for the transaction (1502). For example, stablecoin selector 1404 can select stablecoin type 1212C. In one aspect, stablecoin selector 1404 accessing stablecoin records 1211. Stablecoin selector 1404 considers and/or compares the stability and other characteristics of different coin types included in stablecoin records 1211. Based on stability 1213C and/or other characteristics 1214C, stablecoin selector 1404 can select coin type 1212C.

Stablecoin selector 1404 can consider/compare indicated stability of different stablecoins relative to one another. For example, stablecoin selector 1404 can compare stability 1213A, 1213B and 1213C to one another. From the comparison, stablecoin selector 1404 can determine that stability 1213C indicates increased stability relative to stabilities 1213A and 1213B. Based on the indicated increased stability, stablecoin selector 1404 can select stablecoin type 1212C.

In some aspects, stablecoin selector 1404 also compares other characteristics of stablecoins when selecting a stablecoin. For example, if two stablecoins are equally stable within a margin of error, stablecoin selector 1404 may compare pricing transparency of the two stablecoins. Stablecoin selector 1404 may select the stablecoin with increased pricing transparency. Prior to selecting a stablecoin, stablecoin selector 1204 can also check, in view of other characteristics in stablecoin records 1211, that a stablecoin is permitted for a transaction type, is permitted for use in a transaction for a type of asset, etc.

Method 1500 includes converting the amount of the currency type to an equally valued amount of the selected stablecoin (1503). For example, buyer side converter 1402 can convert amount 1412 of currency type 1411 to amount 1414 of stable coin type 1212C. Buyer side converter 1402 can refer to currency pair 1421. Buyer side converter 1402 can calculate amount 1414 from amount 1414 based on values in currency pair 1421.

Method 1500 includes depositing the amount of the selected stablecoin in a platform stablecoin account (1504). For example, buyer side converter 1502 can deposit amount 1414 of stablecoin 1212C in platform stablecoin account 1408. Method 1500 includes withdrawing the amount of the selected stablecoin from the platform stablecoin account (1505). For example, seller side converter 1403 can withdraw amount 1414 of stablecoin 1212C from platform stablecoin account 1408.

Optionally, after withdrawal, seller side converter 1403 may deduct a fee amount from amount 1414 to cover fees associated with the transaction. Seller side converter can convert the fee amount of stablecoin 1212C into an appropriate currency or currencies for parties to which fees are due. In other aspects, fees may be deducted from amount 1412 of currency type 1411 prior to conversion to stablecoin type 1212C and/or deposit of amount 1414 of stablecoin type 1212C in platform stablecoin account 1408.

Method 1500 includes converting the amount of the selected stablecoin (possibly minus any fees) into an equally valued amount of a seller preferred currency (1506). For example, seller side converter 1402 can convert amount 1414 (possibly minus any fees) of stablecoin type 1212C into amount 1417 of currency type 1416. Currency type 1416 may be a crypto type, a stablecoin type, or a fiat type. In one aspect, seller side converter 1403 refers to account preferences of a user associated with seller custody module 1407 to identify currency type 1416 as the seller preferred currency.

Method 1500 includes disbursing trade proceeds to a seller (1507). For example, currency conversion engine 1401 can send amount 1417 of currency type 1416 at seller custody module 1407.

In one aspect of method 1500, at least one of currency type 1411 and currency type 1416 is a crypto type. As such, conversion into and out of stablecoin type 1212C reduces potential adverse financial impacts on parties associated with the transaction due to crypto volatility.

### Transactions with Currency Conversions

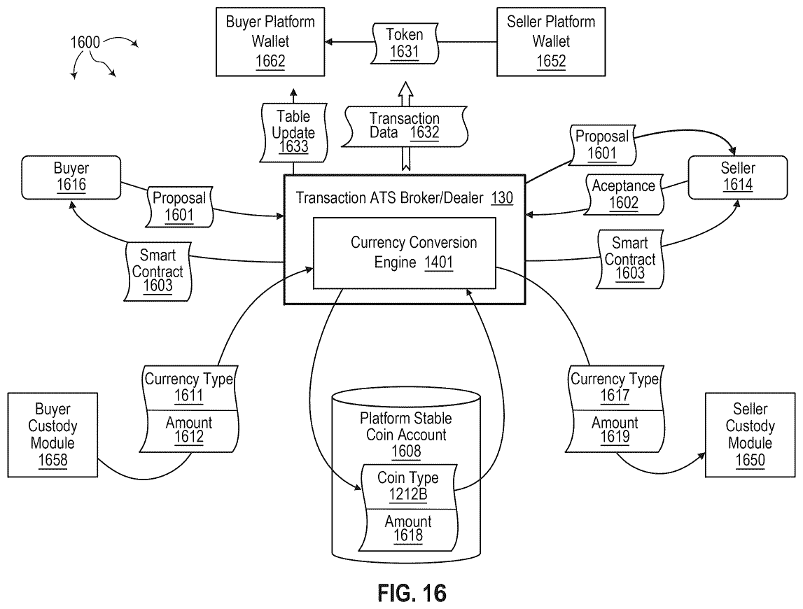

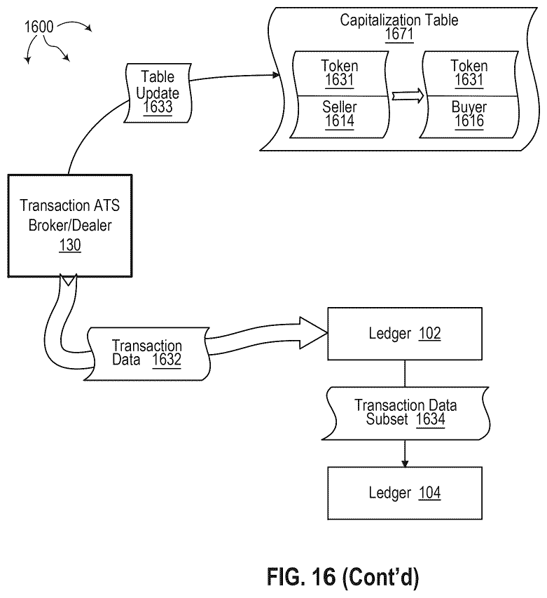

As described, transactions at system 100 can include currency conversions. FIG. 16 illustrates an example computer architecture 1600 that facilitates settling a transaction including currency conversions. The components of FIG. 16 can include, be implemented within and/or can interoperate with any of the components in FIGS. 1-7, of computer system 800, of registration process 900, of sell flow 1000, or of buy flow 1100, including one or more of: broker dealer API 1006/1026/1036, transfer agent API 1010/1040, verify details 1012, transfer agent API 1106/1158/1120/1146, confirm purchase 1112, broker dealer API 1116/1130/1140, transaction service 1153, settlement service 1154, etc. More specifically, computer architecture 1600 depicts transaction ATS broker/dealer 130, which further includes conversion engine 1401, and also depicts primary ledger 102 and secondary ledger 104 (which may house master account ledger 920 and escrow ledger 922).

Seller 1614 can own token 1631 representing a fractional interest in an asset. Ownership of token 1631 can be indicated in capitalization table 1671 for the asset. Buyer 1616 may desire to purchase token 1631 from seller 1614.

Computer architecture 1600 also includes buyer platform wallet 1662, buyer custody module 1658, seller platform wallet 1652, seller custody module 1650, and platform stablecoin account 1608.

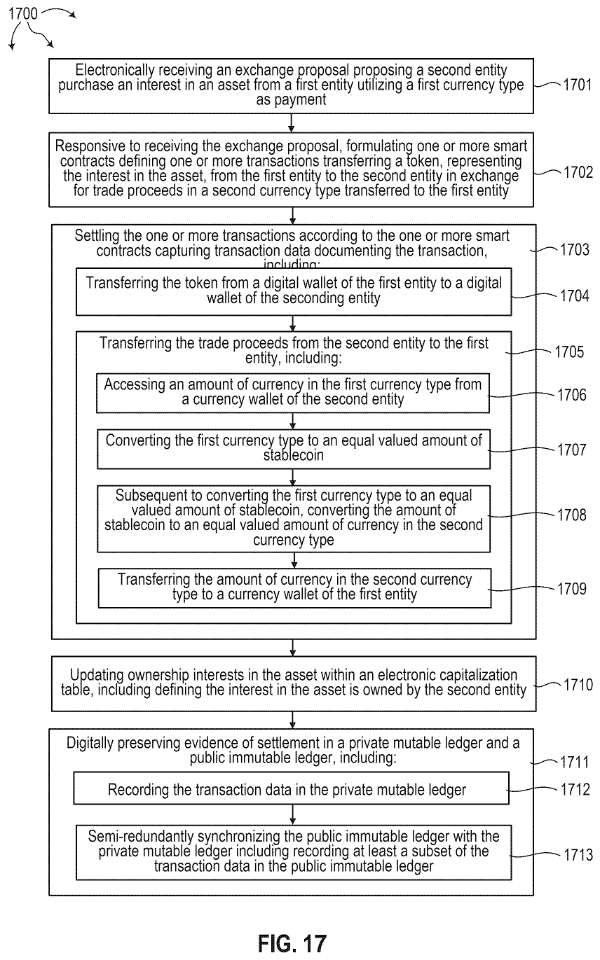

FIG. 17 illustrates a flow chart of an example method 1700 for settling a transaction including currency conversions. Method 1700 will be described with respect to the components and data in computer architecture 1600. As such, method 1700 is suitable for use any of the components in FIGS. 1-7, of computer system 800, of registration process 900, of buy flow 1000, or of sell flow 1100.

Method 1700 includes electronically receiving an exchange proposal proposing a second entity purchase an interest in an asset from a first entity utilizing a first currency type as payment (1701). For example, buyer 1601 can send proposal 1601 to transaction ATS broker/dealer 130. Proposal 1601 can propose that buyer 1616 purchase token 1631 from seller 1614 utilizing amount 1612 of currency type 1611 for payment. Currency type 1611 can be a crypto type, a fiat type, or a stablecoin type.

Transaction ATS broker/dealer 130 can refer to account settings of seller 1614 to identify currency type 1617 as a preferred currency type for seller 1614. From a relevant currency pair, transaction ATS broker/dealer 130 can calculate that amount 1612 of currency type 1611 would convert to a corresponding equally valued amount of currency type 1617 (possibly minus any fees), such as, amount 1619. Transaction ATS broker/dealer 130 can send proposal 1601 to seller 1614 indicating that sale of token 1631 to buyer 1616 would net trade proceeds of amount 1619 of currency type 1617. As such, seller is unaware that buyer 1616 is using currency type 1611 for purchase.

Seller 1614 may approve of proposal 1601 and return acceptance 1602 back to transaction ATS broker/dealer 130.

Method 1700 includes, responsive to receiving the exchange proposal, formulating one or more smart contracts defining one or more transactions transferring a token, representing the interest in the asset, from the first entity to the second entity in exchange for trade proceeds in a second currency type transferred to the first entity (1702). For example, responsive to proposal 1601 and acceptance 1602, transaction ATS broker/dealer 130 can formulate smart contract 1603. Smart contract 1603 can define a transaction wherein: (1) buyer 1616 transfers amount 1612 of currency type 1611 to transaction ATS broker/dealer 130 and in exchange receives token 1631 from seller 1614 and (2) seller 1614 receives trade proceeds in amount 1619 of currency type 1617 and in exchange sends token 1631 to buyer 1616.

Transaction ATS broker/dealer 130 can send smart contract 1603 to each of buyer 1616 and seller 1614.

In some aspects, transaction ATS broker/dealer 130 formulates a buyer smart contract with buyer 1616 and formulates a separate seller contract with seller 1614. Using separate buyer and seller contracts, transaction ATS broker/dealer 130 can obscure some buyer information from the seller and obscure some seller information from the buyer. More specifically, the transaction ATS broker/dealer 130 can obscure a currency type used by buyer 1616 from seller 1614. Similarly, transaction ATS broker/dealer 130 obscure a currency type used by seller 1614 from buyer 1616.

For example, a buyer side contract can define that buyer 1616 is to transfer amount 1612 of currency type 1611 to transaction ATS broker/dealer 130 and in exchange ATS broker/dealer 130 is to transfer token 1631 to buyer 1616. Similarly, a seller side contract can define that seller 1614 is to transfer token 1631 to transaction ATS broker/dealer 130 and in exchange ATS broker/dealer 130 is to transfer amount 1619 or currency type 1617 to seller 1614.

Transaction ATS broker/dealer 130 can provide the buyer side contract to buyer 1616 (but not to seller 1614). Transaction ATS broker/dealer 130 can provide seller sider contract to seller 1614 (but not to buyer 1616). As such, each party is aware of their corresponding transaction and details but not of aware of the other party's transaction and details. Thus, seller 1614 is not aware buyer 1616 is transacting in currency type 1611 and, correspondingly, buyer 1616 is not aware seller 1614 is transacting in currency type 1617. Transaction ATS broker/dealer 130 handles currency conversions permitting each part to transact in a desired (or preferred) currency.

Method 1700 includes settling one or more transactions according to the one or more smart contracts capturing transaction data documenting the transaction (1703). For example, in one aspect, transaction ATS broker/dealer 130 can settle a transaction according to smart contract 1603. Alternately, in another aspect, transaction ATS broker/dealer 130 can settle a buyer side contract with buyer 1616 and a seller side contract with seller 1614.

In either aspect, transaction ATS broker/dealer 130 captures transaction data 1632 documenting the transaction (or transactions) and table update 1633. Transaction data 1632 can include currency type 1611, amount 1612, currency type 1617, amount 1619, buyer 1616, seller 1614, an indication token 1631 was transferred from seller 1614 to buyer 1616, an indication that buyer 1616 purchased token 1631 for amount 1612 of currency type 1611, that seller 1614 received trade proceeds of amount 1619 of currency type 1617, stablecoin types used during a transaction (e.g., coin type 1212B), stablecoin amounts used during a transaction (e.g., 1618), conversions between stablecoin and other currency, etc.

Settling one or more transactions (1703) includes transferring the token from a digital wallet of the first entity to a digital wallet of the seconding entity (1704). For example, transaction ATS broker/dealer 130 can transfer token 1631 from seller platform wallet 1652 to buyer platform wallet 1662.

Settling one or more transactions (1703) includes transferring the trade proceeds from the second entity to the first entity (1705). For example, transaction ATS broker/dealer 130 can disburse amount 1619 of currency type 1617 to seller custody module 1650.

Transferring the trade proceeds (1705) includes accessing an amount of currency in the first currency type from currency wallet of the second entity (1706). For example, transaction ATS broker/dealer 130 can access amount 1612 of currency type 1611 from buyer custody wallet 1658. Transferring the trade proceeds (1705) includes converting the first currency type to an equal valued amount of stablecoin (1707). For example, currency conversion engine 1401 can convert amount 1612 of currency type 1611 to amount 1618 of coin type 1212B. Coin type 1212B can be selected due to increased stability relative to other stablecoin types, potentially through reference to stablecoin records 1211.

Currency conversion engine 1401 can deposit amount 1618 of coin type 1212B in platform stablecoin account 1608. Subsequently, and concurrently with transferring token 1631, currency conversion engine 1401 can withdraw amount 1618 of coin type 1212B from platform stablecoin account 1608.

Transferring the trade proceeds (1705) includes subsequent to converting the first currency type to an equal valued amount of stablecoin, converting the amount of stablecoin to an equal valued amount of currency in the second currency type (1708). For example, currency conversion engine 1401 can convert amount 1618 of coin type 1212B (possibly minus any fees) to amount 1619 of currency type 1617. Transferring the trade proceeds (1705) includes transferring the amount of currency in the second currency type to a currency wallet of the first entity (1709). For example, transaction ATS broker/dealer 130 can disburse amount 1619 of currency type 1617 to seller custody module 1650.

In another aspect, transaction ATS broker/dealer 130 settles a buyer side transaction with buyer 1616 in accordance with a buyer side contract and settles a seller side transaction with seller 1614 in accordance with a seller side contract. Settling the buyer side contract can include buyer 1616 transferring amount 1612 of currency type 1611 (a purchase price) to transaction ATS broker/dealer 130 in exchange for transaction ATS broker/dealer 130 sending token 1631 to buyer 1616. Settling the seller side contract can include seller 1614 sending token 1631 to transaction ATS broker/dealer 130 in exchange for transaction ATS broker/dealer 130 sending amount 1619 of currency type 1617 (trade proceeds) to seller 1614. Buyer 1616 and seller 1614 each perform in accordance with their corresponding contract and have no knowledge of the currency type being used by the other party. That is, seller 1614 has no knowledge buyer 1616 is transacting in currency type 1611 and similarly buyer 1616 has no knowledge seller 1614 is transacting in currency type 1617.

Transaction ATS broker/dealer 130 can hold currency and/or token 1631 in escrow until both a buyer side contract and/or a seller side contract settle. In one aspect, transaction ATS broker/dealer 130 initially obtains token 1631 (in accordance with the seller side contract) and amount 1612 of currency type 1611. Subsequently, after both token 1631 and amount 1612 of currency type 1611 are successfully obtained, Transaction ATS broker/dealer 130 sends token 1631 to buyer 1616 and amount 1619 of currency 1617 (after conversion through coin type 1212B) to seller 1614.

In one aspect, at least one of currency type 1611 and currency type 1619 is a crypto type. As such, conversion into and out of stablecoin type 1212B reduces potential adverse financial impacts on parties associated with the transaction due to crypto volatility.

Method 1700 includes updating ownership interests in the asset within an electronic capitalization table, including defining the interest in the asset is owned by the second entity (1710). For example, transaction ATS broker/dealer 130 can implement table update 1633 to capitalization table 1671. Table update 1633 can alter capitalization table 1671 to indicate that seller 1614 does not own token 1631 and that buyer 1616 does own token 1631.

Method 1700 incudes digitally preserving evidence of settlement in a private mutable ledger and a public immutable ledger (1711). For example, transaction ATS broker/dealer 130 can preserve evidence of transaction (or transactions) settlement in ledgers 102 (a private mutable ledger) and 104 (a public immutable ledger). Digitally preserving evidence of settlement (1711) includes recording the transaction data in the private mutable ledger (1712). For example, transaction ATS broker/dealer 130 can record transaction data 1632 in ledger 102.

Digitally preserving evidence of settlement (1711) includes semi-redundantly synchronizing the public immutable ledger with the private mutable ledger including recording at least a subset of the transaction data in the public immutable ledger (1713). For example, transaction data subset 1634 can be synchronized to ledger 102. Transaction data subset 1634 can be a subset of transaction data 1632. Data subset 1634 may include some but not all and/or partially redacted portions of: currency type 1611, amount 1612, currency type 1617, amount 1619, buyer 1616, seller 1614, an indication token 1631 was transferred from seller 1614 to buyer 1616, an indication that buyer 1616 purchased token 1631 for amount 1612 of currency type 1611, that seller 1614 received trade proceeds of amount 1619 of currency type 1617, coin type 1212B, amount 1618, conversion between currency type 1611 and coin type 1212B, conversion between coin type 1212B and currency type 1617, etc.

In some aspects, transaction data 1632 and portions thereof, such as, data subset 1634, is synced between ledger 102 and ledger 104 in accordance with the described techniques.

### Crypto Currency Based Settlement Service

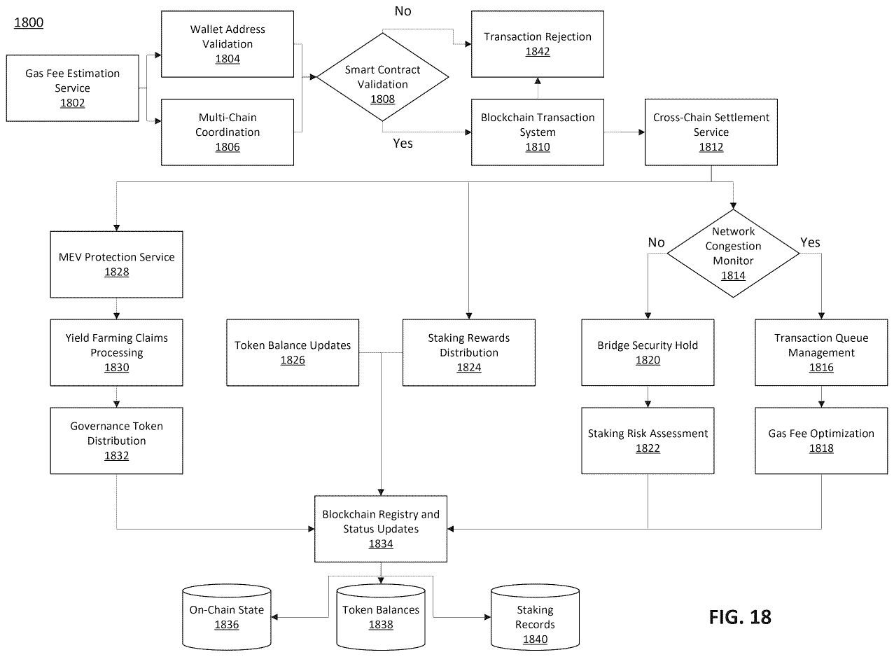

In some aspects, settlement services 1154 offers a settlement service for settling and/or validating a transaction associated with an asset settled with crypto and/or stablecoin. For example, turning to FIG. 18, FIG. 18 depicts an example system and data flow 1800 for settling and/or validating a transaction associated with crypto currency and/or stablecoin. System and data flow 1800 is suitable for use with and/or may be implemented at any of the components in FIGS. 1-7, of computer system 800, of registration process 900, of sell flow 1000, or of buy flow 1100.

As depicted, system and data flow 1800 includes gas fee estimation service 1802, wallet address validation 1804, multi-chain coordination 1806, smart contract validation 1808, transaction rejection 1342, blockchain transaction system 1810, cross-chain settlement service 1812, network congestion monitor 1814, transaction queue management 1816, gas fee optimization 1818, bridge security hold 1820, staking risk assessment 1822, staking rewards distribution 1824, token balance updates 1826, MEV protection service 1828, yield farming claims processing 1830, governance token distribution 1832, block chain registry and status updates 1834, on-chain state 1836, token balances 1838, and staking records 1340.

Initially, system and data flow 1800 can include a pre-settlement phase with gas fee estimation service 1802, wallet address validation 1804, and multi-chain coordination 1806 performing various operations.

Generally, gas fee estimation service 1802 determines the optimal transaction costs and timing using current network conditions across multiple available blockchains. A gas fee is a blockchain transaction fee paid to process and validate blockchain transactions on a blockchain network. Gas fees compensate miners or validators for the computational resources (e.g., processing power and energy) required to execute and verify transactions or smart contracts. Each platform or blockchain network may have a corresponding real-time gas fee and gas fees can vary across different blockchains.

Gas fees can be utilized to reduce network spam or inefficient blockchain transactions, as well as incentivizing validators to maintain the blockchain. Various factors may affect gas fees including, but not limited to: network congestion, transaction complexity, and real-time gas price. High demand on the network may increase gas fees as users compete for blockchain space. Similarly, simple blockchain transactions use less gas which equates to smaller gas fees compared to complex smart contract interactions. In another example, a gas price may be set to a higher gas price to prioritize faster transaction processing.

In one example, gas on Etherium (an example blockchain) is measured in gwei (1 gwei=10⁻⁹ ETH). The total gas fee may be calculated as: Gas Fee=Gas Used×Gas Price (where Gas Price is in gwei, and Gas Used depends on the transaction's complexity).

In some aspects, gas fee estimation service 1802 identifies current base fee(s) and priority fee(s) corresponding to multiple blockchains. Gas fee estimation service 1302 analyzes historical gas price patterns and network usage to calculate estimated confirmation times for different gas price levels taking into consideration transaction complexity (e.g., simple blockchain transfer vs. complex decentralized finance (DeFi) interaction). Gas fee estimation service 1302 also provides recommendations for immediate, or delayed execution based on real-time gas fees for multiple available blockchain platforms.

Gas fee estimation service 1802 may include a network monitoring agent for real-time monitoring of memory pool (e.g., mempool) congestion across available supported blockchains including but not limited to, Ethereum, Polygon, Arbitrum, Optimism, etc. A mempool is a decentralized waiting area where unconfirmed blockchain transactions are temporarily stored after being broadcast to the network but before being included in the block. Each node on a blockchain network maintains its own version of the mempool, which acts as a buffer, allowing miners or validators to select transactions, prioritizing those with higher transaction fees, to add to the next block.

Gas fee estimation service 1802 may interact with a gas price oracle (or gas price estimator), which aggregates gas price data from multiple sources including, but not limited to EthGasStation, Blocknative, or proprietary models. A gas price oracle (or gas price estimator) may include a third-party service that connects smart contracts formulated in system 100 with third-party entities and third-party systems outside of system 100. The gas price oracle (or gas price estimator) may provide a user of system 100 with an estimate of the current gas fee for a transaction. The gas price oracle (or gas price estimator) can aggregate data about the current network conditions (e.g., congestion, pending transactions, block inclusion rates) and then generates a recommended gas price and/or priority fee. Mempools may be inspected to scan and analyze pending transactions, associated bid fees and the speed they are mined. Similarly, block analysis may be performed to determine gas usage per block, base fee and priority distributions, while taking into consideration network statistics (e.g., gas demand versus block limit). The gas price oracle (or gas price estimator) may generate a recommended gas price by statistically analyzing successful transaction fees (e.g., median of last N included transactions) in multiple tiers (e.g., fast, average, safeLow).

In some aspects, gas fee estimation service 1802 includes a transaction priority calculator. The transaction priority calculator can determine optimal gas price based on urgency and cost tolerance. Urgency is how fast the user needs the transaction to be confirmed, while the cost tolerance is how much the user is willing to pay in fees. There may be different tiers of urgency (e.g., low, medium, and high) and cost tolerance (e.g., low, medium, high), with different variations of combinations of associated urgency and cost tolerances mapping to a distinct priority bracket with associated strategy. For example, a high urgency and high cost tolerance may process the transaction in the next block, whereas a medium urgency and medium cost tolerance may allow confirmation in 2-5 blocks.

Further, gas fee estimation service 1802 may also include a Layer 2 comparison module to compare costs across different Layer 2 solutions for the same operation. A blockchain Layer 2 is a secondary protocol built on top of a base blockchain that improves scalability, transaction throughput, and cost efficiency without compromising the security of the underlying Layer 1. The Layer 2 processes transactions outside the main chain (e.g., off-chain), then periodically anchors or commits the results back to Layer 1.

Additionally, gas fee estimation service 1802 may include a Maximum Extractable Value (MEV) impact assessment module. The MEV impact module can perform a MEV impact assessment including estimating the maximum extractable value impact on transaction costs. The MEV impact assessment is essentially a risk and performance audit for blockchains and DeFi protocols that quantifies how much value is extracted by transaction reordering, insertion, or censoring, how it affects users and system fairness, and what mitigation mechanisms are needed to maintain security, decentralization, and trust.

Gas fee estimation service can pass an estimated gas fee (or estimated gas fees) to wallet address validation 1804 and/or multi-chain coordination 1806. Wallet address validation 1804 can comprehensively validate wallet addresses, smart contract interactions, and signature requirements. In some aspects, wallet address validation 1304 confirms sufficient native token balance for estimated gas fees.

Wallet address validation 1804 may include an address format validator that validates wallet address checksums and wallet address format compliance across different blockchain address formats. Wallet address compliance verifies whether a given blockchain address is permitted, restricted, or risky before executing the transaction and may include: (1) Sanctions and blacklist screening-Checking wallet addresses against global sanction lists (e.g., Office of Foreign Assets Control Specifically Designated Nations and Blocked Persons (OFAC SDN) list, European Union consolidated sanctions list, UN Security Council, United Kingdom His Majesty's Treasury (UK HMT list)), and reporting/blocking the transaction if an address appears. (2) AML/KYC/KYT (Know Your Transaction)-Ensuring the wallet belongs to an identified, verified user, while also identifying any potential ties to illicit activity (e.g., hacks, ransomware, darknet markets), high-risk geographies (e.g., jurisdictions with weak AML enforcement), or links to frauds or scams. (3) Transaction Monitoring and Ongoing Compliance-Continuously monitoring transactions in real-time to/from the wallet for suspicious patterns (e.g., structuring, layering). Large or unusual transfers are flagged, enhanced due diligence is performed for certain institutional or high-value transactions, pattern recognition detects mixers, peel chains, dusting attacks.

Wallet address validation 1804 may also include a smart contract detector and contract security scanner. The smart contract detector identifies if a target wallet address is an externally owned account (EOA), or a smart contract. Wallet Address Validation 1304 may check if a wallet address exists and has been used previously. Wallet Address Validation 1804 may further include a contract security scanner that performs basic security analysis of target smart contracts. The contract security scanner may validate bytecode in smart contracts, check for proxy patterns, and review upgrade mechanisms. The contract security scanner may also validate the wallet has proper permissions for various operations. Wallet Address Validation 1804 may additionally include a signature verification service that validates digital signatures and multi-signature requirements. Signature verification service may ensure wallet nonce synchronization across multiple pending transactions. A nonce, or number used once, is a random or pseudo-random number used only once in cryptographic communication used to prevent replay attacks, where an attacker intercepts and resubmits a valid communication to gain unauthorized access or perform malicious actions. A transaction nonce may be a monotonically increasing counter associated with each account. The first transaction from an address has a nonce value of 0 with each valid transaction incrementing by 1. Wallet nonce synchronization ensures a blockchain account uses the correct nonce value when submitting transactions, so they are accepted by the network and executed in the right order.

By enforcing ordering of transactions from the same account, nodes can detect missing, duplicate, or out of order transactions. When multiple services send transactions from the same wallet, they need to be coordinated. If two transactions are sent with the same nonce, one gets rejected. If a transaction skips a nonce, later transactions are stuck in the mempool until the missing nonce is filled. In high-frequency platforms in the current disclosure, there are multiple parallel processes each generating distinct transactions, making nonce misalignment prevalent. The wallet nonce synchronization aside from providing extra security, protects the integrity of data and transactions.

Wallet Address Validation 1804 may also include a wallet connectivity monitor that ensures wallet connection stability and proper remote procedure call (RPC) communication. RPC allows decentralized applications and other clients to communicate with blockchain nodes to request data, execute transactions, and interact with smart contracts. RPC acts as a gateway, enabling external systems to send commands to the blockchain network, receive results, and access information like block data or account balances, all without needing to run a full node themselves.

Multi-chain coordination 1806 can run in parallel to wallet address validation 1304. In some aspects, multi-chain coordination 1806 manages cross-chain operations, bridge protocols, and timing coordination across different blockchain networks. A bridge protocol enables interoperability between two independent blockchains, allowing assets, data, or messages to move across blockchains. Blockchains are isolated environments with their own consensus rules and state machines, so bridge protocols provide the cryptographic, economic, or trust-based mechanisms to transfer values and information between the two independent blockchains so they can interact and validate each other. In a bridge, tokens are not transferred or moved across chains. Tokens on the source chain are locked, or burned. Subsequently, equivalent tokens on the destination chain are minted, or released. Proofs, or events, between chains are relayed using validators, relayers or smart contracts. In some aspects, Multi-Chain Coordinate 1306 may include a bridge protocol manager to interface with other bridge protocols including, but not limited to Hop, Synapse, Multichain, LayerZero, etc.

Multi-chain coordination 1806 may include a chain state synchronizer to monitor finality and confirmation status across multiple blockchains. Multi-chain coordination 1306 can validate bridge protocol availability and liquidity. Multi-chain coordination 1306 may calculate optimal routing for cross-chain transfers (e.g., direct vs multi-hop). Multi-chain coordination 1306 may monitor bridge fee structures and select the most cost-effective option. Multi-chain coordination 1306 may coordinate timing to handle different block confirmation requirements. Multi-chain coordination 1306 may also manage contingency plans for bridge failures or congestion. Multi-chain coordinate 1306 may validate destination chain readiness for incoming transfers.

Multi-Chain Coordination 1806 may also include a cross-chain message relayer to handle message passing between blockchains for some (e.g., more complex) operations. Multi-chain coordination 1306 may also include an atomic operation coordination to ensure atomicity in multi-chain transactions. Atomicity in multi-chain transactions ensures that a set of operations spanning multiple blockchains is executed in an all-or-nothing manner. Either all legs of the cross-chain transaction succeed, or none of them take effect and the state reverts safely back to the pre-transaction state. Atomicity is challenging given blockchains are isolated state machines that do not share a global transaction log or consensus. For example, a user may want to swap ETH on Ethereum for BTC on Bitcoin. If atomicity is not guaranteed, ETH might be sent on Ethereum but BTC is never released on Bitcoin. A user could lose funds or create inconsistent states across chains. In one implementation, hashed timelock contracts may be used for atomicity, where both parties lock funds on their respective chains with a hash lock hash(x). Whenever a party reveals x to claim funds on one blockchain, x is automatically revealed to the other blockchain. If time expires without claiming, refunds occur. This helps ensure an all or nothing transfer across two or more blockchains.

In another aspect, cross-chain messaging with relayers is used for atomicity. Different blockchains have different consensus, and/or finality times. A transaction in the “final” state on Ethereum may still be reorganized on another blockchain. Asynchronous communication also presents challenges. Some blockchains do not communicate in real-time and, as such, race conditions may occur. Middleware (e.g., bridges or interoperability protocols) ensure atomicity by relaying proofs. A Blockchain A transaction is only considered final when Blockchain B verifies a proof. If verification fails, the transaction does not execute. In another implementation, coordinating validators or relayers may execute or abort both sides of a transaction.

Cross-Chain Verification 1806 may also include bridge security monitor to provide real-time monitoring of bridge protocol health and security incidents.

After either wallet address verification 1804 and/or multi-chain coordination 1806 perform one or more of the various described operations, smart contract validation 1808 checks for smart contract completion. A comprehensive validation may be performed that smart contracts are properly deployed, audited, and have sufficient permissions. Smart contract validation 1308 may include a contract deployment verification to confirm contracts exist and are properly deployed. Smart contract validation 1308 may also include audit status check to verify contracts have passed security audits. Smart contract validation 1308 may further include permission validation to ensure contracts have necessary approvals and allowances. Smart contract validation 1308 may additionally include a state consistency check to validate contract state is ready for proposed operations as well as an upgrade status monitor to check for pending contract upgrades that might affect operations. If any validation fails (NO at 1808), the transaction is rejected 1842. If smart contract validation is complete (YES at 1808), operations can transition to a core settlement processing phase including blockchain transaction system execution 1810 and cross chain settlement service 1812.

In some aspects, blockchain transaction system execution 1810 coordinates transaction broadcasting, monitoring and lifecycle management. Blockchain transaction system execution 1810 can include a transaction builder to construct raw transactions with optimal parameters (e.g., network conditions determining optimal transaction costs and timing). Blockchain transaction system execution 1810 may include a nonce manager to manage the transaction nonces across multiple wallet operations, including managing transaction dependencies and ordering. Blockchain transaction system execution 1810 may include a broadcasting service to submit transactions to multiple RPC endpoints for redundancy. Blockchain transaction system execution 1810 may include a status monitor for real-time tracking of transaction status across networks to identify real-time inclusion and confirmation status. Blockchain transaction system execution 1810 may also include a replacement strategy engine for handling transaction replacement strategies including transaction acceleration and cancellation, as well as handling failed transactions and automatic retry logic. The replacement strategy engine may coordinate with mempool monitoring to determine optimal timing.

Cross-chain settlement service 1812 can execute settlement operations including: cross-chain transfers, atomic swaps, and complex DeFi interactions (e.g., swaps, lending, staking). In some aspects, the cross-chain settlement service 1812 executes single-chain settlements (e.g. token transfers, smart contract interactions) and coordinates cross-chain settlements using bridge protocols. Cross-chain settlement service 1812 may include a bridge transaction coordinator to manage bridge protocol interactions and an atomic swap engine to handle trustless cross-chain asset exchanges facilitating all-or-nothing execution. Cross-chain settlement service 1812 may also include a liquidity pool manager to optimize liquidity provision and withdrawal. Cross-chain settlement service 1312 may also include a batch transaction processor to optimize and combine multiple operations for gas efficiency. A MEV protection layer implements front-running and sandwich attack protection strategies (e.g., private mempools, commit-reveal schemes, etc).

In some aspects, network congestion monitor 1314 then monitors for network congestion. When network congestion is detected (YES at 1814), 1800 proceeds to transaction queue management 1816 and gas fee optimization 1818, which can make gas fee adjustments in view of network congestions. When network congestion is not detected (NO at 1814), 1800 proceeds to bridge security hold 1820 and subsequently staking risk assessment 1322.

A post-settlement processing phase, including staking rewards distribution 1824 and token balance updates 1826, can also follow cross-chain settlement service 1812. Staking rewards distribution 1824 processes validator rewards, delegation rewards, and manages staking related operations. Staking enables users to leverage existing assets to obtain additional buying power. Staking is a process where a user locks up their asset holdings to support the platform's operations, and in exchange for this commitment, earn rewards (e.g., additional cryptocurrency, voting rights, other benefits, etc.). Staking rewards distribution 1824 calculates rewards based on validator performance, distributes rewards to delegators proportionally, and manages slashing events and penalty distribution. Staking rewards distribution 1824 can handle liquid staking token minting and redemption as well as implementing auto-compounding strategies. Staking rewards distribution 1824 may coordinate with multiple staking protocols across different chains. Staking rewards distribution 1824 may also manage staking derivative operations (e.g., stETH, rETH, etc.).

Token balance updates 1826 can maintain accurate token balances across multiple chains and updates liquidity positions. The token balance system processes ownership changes resulting from completed transactions, token transfers, corporate actions, and other events that affect user holdings. In some cases, Token balance updates 1826 coordinates with both primary and secondary ledger infrastructures to ensure consistent balance information while maintaining appropriate privacy protections and audit trail requirements. The system implements atomic balance update procedures that prevent partial updates or inconsistent states during transaction processing.

1800 can include (e.g., advanced) web3 functionality such as Maximum extractable value (MEV) protection services 1828, yield farming claims processing 1830, and governance token distribution 1832. MEV protection services implement safeguards against front-running attacks and sandwich attacks that can negatively impact transaction execution. Private mempool managers route sensitive transactions through protected environments such as Flashbots and Eden to prevent exploitation by malicious actors. MEV Protection layers utilize commit-reveal schemes and other cryptographic techniques to shield price-sensitive operations from manipulation. The system participates in MEV sharing protocols to capture value for users rather than allowing extraction by third parties. Transaction ordering optimizers analyze and adjust transaction sequencing to minimize MEV impact while maintaining execution efficiency.

The methods, systems, and technologies of the present invention can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

The systems in FIGS. 1-7, computer system 800, registration process 900, sell flow 1000, buy flow 1100, computer system 1200, method 1300, computer system 1400, method 1500, computer system 1600, method 1700, method 1800, etc. can be implemented in a cloud computing environment and/or using a cloud computing model.

An example initial use case for the disclosed technology is for use within a financial exchange that includes a primary or secondary market for digital shares of assets, such as, an Alternative Trading System (ATS).

Each of the processes, methods, and algorithms described in the preceding sections may be embodied in, and fully or partially automated by, code components executed by one or more computer systems or computer processors comprising computer hardware. Each of the processes, methods, and algorithms described in the preceding sections may occur sequentially, partially sequentially, partially concurrently, or fully concurrently. For example, coin characteristic derivation module 1201, coin data ingestor 1203, currency conversion engine 1401, buyer side converter 1402, seller side converter 1403, stablecoin selector 1404, etc. may be participating in different aspects of currency conversion for multiple transactions at any time. Different portions of the processes, methods, and algorithms described in the preceding sections may occur sequentially, partially sequentially, partially concurrently, or fully concurrently. For example, currency conversion engine 1401 may be concurrently performing multiple currency conversions and the currency conversions may be happening concurrently with coin characteristic derivation module 1201 deriving stablecoin characteristics all while escrow ledger 922 is also tracking in flight funds (e.g., any of fiat, stablecoin, crypto, etc.) associated with one or more transactions.

The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits.

Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as the computer system 800. In example embodiments, system 100, computer architecture 1200, computer architecture 1400, computer architecture 1600, etc. provide currency conversion suitable for converting currency associated with asset trading and/or on a financial exchange.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or activities.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

In one aspect, a method may include an operation, an instruction, and/or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

The functions, acts or tasks illustrated in the Figures or described may be executed in a digital and/or analog domain and in response to one or more sets of logic or instructions stored in or on non-transitory computer readable medium or media or memory. The functions, acts or tasks are independent of the particular type of instructions set, storage media, processor or processing strategy and may be performed by software, hardware, integrated circuits, firmware, microcode and the like, operating alone or in combination. The memory may comprise a single device or multiple devices that may be disposed on one or more dedicated memory devices or disposed on a processor or other similar device.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method comprising:
presenting a user-interface screen depicting an interest in an asset for sale at a listed price;
permitting purchase of the interest in the asset based on the financial position of a buyer including:
checking the balance of a buyer crypto currency wallet; and
tracking in flight funds between the buyer and accounts external to a transaction system; and
settling a sale of the interest in the asset from a seller to the buyer in accordance with a smart contract, including:
receiving, at the transaction system, an amount of a first crypto currency type from the buyer crypto currency wallet;
converting the amount of the first crypto currency type to a corresponding amount of a stablecoin type;
subsequent to converting the amount of the first crypto currency type to an equal valued amount of a stablecoin type, converting the amount of stablecoin type to corresponding amount of a second currency type;
transferring the amount of the second currency type from the transaction system to a seller currency wallet; and
responsive to transferring the amount of the second currency type, transferring one or more tokens representing the interest in at asset from a seller digital asset wallet to a buyer digital asset wallet.

2. The method as recited in claim 1, wherein converting the amount of stablecoin type to corresponding amount of a second currency type comprises converting the amount of the stablecoin type to corresponding amount of a second crypto currency type; and
wherein transferring the amount of the second currency type from the transaction system to a seller currency wallet comprises transferring the amount of the second crypto currency type from the transaction system to a seller crypto currency wallet.

3. The method as recited in claim 1, further comprising selecting the stablecoin type from among a plurality of stablecoin types based on stability characteristics of the stablecoin type relative to stability characteristics of one or more other stablecoin types in the plurality of stablecoin types.

4. The method of claim 1, wherein checking the balance of the buyer crypto currency wallet comprises checking the balance of the buyer crypto currency wallet via a master account ledger maintained in a public immutable ledger at the transaction system; and
wherein tracking in flight funds between the buyer and accounts external to the transaction system comprises tracking in flight crypto currency funds between the buyer and accounts external to the transaction system via an escrow ledger maintained in the public immutable ledger at the transaction system.

5. The method of claim 4, further comprising digitally preserving evidence of the sale in a private mutable ledger and the public immutable ledger, including:
recording data resulting from settling the sale in the private mutable ledger; and
semi-redundantly synchronizing the public immutable ledger with the private mutable ledger including recording at least a subset of the data resulting from settling the sale in the public immutable ledger.

6. The method of claim 1, further comprising prior to presenting the user interface screen, registering the seller on the transaction system, including:
verifying the identity of the seller;
verifying that an existing capitalization table indicates the seller is an investor in the asset;
prompting the seller that the seller owns the interest in the asset;
confirming that the seller opts to claim the interest in the asset; and
updating the capitalization table to reflect details of the seller as the investor.

7. The method of claim 6, further comprising, subsequent to settling the sale of the interest in the asset, updating the capitalization table to indicate the sale of the interest in the asset.

8. The method of claim 1, further comprising registering the seller, including:
verifying the seller using one of: a know your customer (KYC) approval process or a know your business (KYB) approval process; and
determining that the seller appears on a capitalization table.

9. The method of claim 1, wherein presenting a user-interface screen depicting an interest in an asset for sale at a listed price comprises presenting a user-interface screen depicting the interest in the asset for sale, the asset selected from among: a franchise, a commodity, a natural resource, a private credit, a private debt, or real estate.

10. The method of claim 1, further comprising:
determining that the seller owns a specified number of shares in the asset; and
determining that the depicted interest represents less than all of the specified number of shares; and
wherein transferring the one or more tokens comprises transferring the one or more tokens in accordance with a First In First Out (FIFO) algorithm.

11. A system comprising:
a processor;
system memory coupled to the processor and storing instructions configured to cause the processor to:
present a user-interface screen depicting an interest in an asset for sale at a listed price;
permit purchase of the interest in the asset based on the financial position of a buyer including:
check the balance of a buyer crypto currency wallet; and
track in flight funds between the buyer and accounts external to a transaction system; and
settle a sale of the interest in the asset from a seller to the buyer in accordance with a smart contract, including:
receive, at the transaction system, an amount of a first crypto currency type from the buyer crypto currency wallet;
convert the amount of the first crypto currency type to a corresponding amount of a stablecoin type;
subsequent to converting the amount of the first crypto currency type to an equal valued amount of a stablecoin type, convert the amount of stablecoin type to corresponding amount of a second currency type;
transfer the amount of the second currency type from the transaction system to a seller currency wallet; and
responsive to transferring the amount of the second currency type, transfer one or more tokens representing the interest in at asset from a seller digital asset wallet to a buyer digital asset wallet.

12. The system of claim 11, wherein instructions configured to cause the processor to convert the amount of stablecoin type to corresponding amount of a second currency type comprise instructions configured to cause the processor to converting the amount of the stablecoin type to corresponding amount of a second crypto currency type; and
wherein instructions configured to cause the processor to transfer the amount of the second currency type from the transaction system to a seller currency wallet comprise instructions configured to cause the processor to transfer the amount of the second crypto currency type from the transaction system to a seller crypto currency wallet.

13. The system of claim 11, further comprising instructions configured to cause the processor to select the stablecoin type from among a plurality of stablecoin types based on stability characteristics of the stablecoin type relative to stability characteristics of one or more other stablecoin types in the plurality of stablecoin types.

14. The system of claim 11, wherein instructions configured to cause the processor to check the balance of the buyer crypto currency wallet comprise instructions configured to cause the processor to check the balance of the buyer crypto currency wallet via a master account ledger maintained in a public immutable ledger at the transaction system; and
wherein instructions configured to cause the processor to track in flight funds between the buyer and accounts external to the transaction system comprise instructions configured to cause the processor to track in flight crypto currency funds between the buyer and accounts external to the transaction system via an escrow ledger maintained in the public immutable ledger at the transaction system.

15. The system of claim 14, further comprising instructions configured to cause the processor to digitally preserve evidence of the sale in a private mutable ledger and the public immutable ledger, including:
record data resulting from settling the sale in the private mutable ledger; and
semi-redundantly synchronize the public immutable ledger with the private mutable ledger including recording at least a subset of the data resulting from settling the sale in the public immutable ledger.

16. The system of claim 11, further comprising instructions configured to cause the processor to, prior to presenting the user interface screen, register the seller on the transaction system:
verify the identity of the seller;
verify that an existing capitalization table indicates the seller is an investor in the asset;
prompt the seller that the seller owns the interest in the asset;
confirm that the seller opts to claim the interest in the asset; and
update the capitalization table to reflect details of the seller as the investor.

17. The system of claim 11, further comprising instructions configured to cause the processor to, subsequent to settling the sale of the interest in the asset, update the capitalization table to indicate the sale of the interest in the asset.

18. The system of claim 11, further comprising instructions configured to cause the processor to register the seller, including:
verify the seller using one of: a know your customer (KYC) approval process or a know your business (KYB) approval process; and
determine that the seller appears on a capitalization table.

19. The system of claim 11, wherein instructions configured to cause the processor to present a user-interface screen depicting an interest in an asset for sale at a listed price comprise instructions configured to cause the processor to present the user-interface screen depicting the interest in the asset for sale, the asset selected from among: a franchise, a commodity, a natural resource, a private credit, a private debt, or real estate.

20. The system of claim 11, further comprising instructions configured to cause the processor to:
determine that the seller owns a specified number of shares in the asset; and
determine that the depicted interest represents less than all of the specified number of shares; and
wherein instructions configured to cause the processor to transfer the one or more tokens comprise instructions configured to cause the processor to transfer the one or more tokens in accordance with a First In First Out (FIFO) algorithm.
